(19) United States
(12) Patent Application Publication
(10) Pub. No.: US 2017/0098197 A1
(43) Pub. Date: Apr. 6, 2017

(54) Systems and Methods for Automatically Collecting User Data and Making a Real-World Action for a User

(71) Applicant: RNA Labs Inc., Mississauga (CA)

(72) Inventors: Raymond YU, Mississauga (CA); Amandeep THAKRAL, Bellevue, WA (US)

(73) Assignee: RNA Labs Inc., Mississauga, ON (CA)

(21) Appl. No.: 15/120,260

(22) PCT Filed: Feb. 21, 2014
(86) PCT No.: PCT/CA2014/050294

§ 371 Date: Aug. 19, 2016

(51) Int. Cl. G06Q 10/10; G06F 17/30; G06F 19/00

(52) U.S. Cl. CPC G06Q 10/1095; G06F 19/322; G06F 17/30312; G06Q 50/01

(57) ABSTRACT

Systems and methods are provided for automatically recommending real-world actions and performing the same. The real-world action includes at least one of a scheduling action and a purchasing action. The method includes: obtaining data about a user; obtaining data about a partner organization; processing the data about the user and the partner organization to recommend the real-world action and to generate a tolerance rule; when the real-world action is within the tolerance rule, automatically performing the real-world action for the user and in collaboration with the partner organization; and when the real-world action is not within the tolerance rule, providing a notification to the user recommending the real-world action be performed.

### TECHNICAL FIELD

The following relates generally to automatically collecting user data and making a real-world action for a user.

### DESCRIPTION OF THE RELATED ART

Technology has become prevalent in many areas of a person's life. For example, in the medical field, doctors are starting to adapt electronic health records to keep track of patients. Typically, when a doctor realizes there is a problem for a patient, the doctor or the doctor's assistant will call the patient to book an appointment. The patient will then need to check their schedule to confirm the appointment. In another scenario, when a patient is ill, the patient will call the doctor's office to book an appointment, and the doctor's assistant or the doctor will check their schedule to confirm the appointment. This booking process can be time consuming for both the doctor and the patient.

For example, in the field of booking events and restaurants, typically a person will search for a restaurant in a directory, such as an Internet or online directory, or a phone directory. The person will then call the restaurant or event coordinator to make a booking. Alternatively, with some Internet booking systems, the person can submit a booking for the restaurant or event via a graphical user interface or by email. This searching and booking process can be time consuming for the person and may also be time consuming for the restaurant and event coordinator.

For example, in the field of e-commerce, a person is able to browse and search through online catalogues and advertisements using their computing device. When the person has found and provided a user input to select a product or service they desire to purchase, the person provides one or more inputs (e.g. passing of credit card information, selecting to check out, etc.) to make the purchase of the product or the service. This searching and purchasing process can be time consuming for the person.

### BRIEF DESCRIPTION OF THE DRAWINGS

Embodiments will now be described by way of example only with reference to the appended drawings wherein:

FIG. 1A is a block diagram illustrating components of an example embodiment of an automatic decision making system.

FIG. 1B is a block diagram illustrating components of another example embodiment of an automatic decision making system.

FIG. 2 is a block diagram further illustrating components of an automatic decision making system.

FIG. 3 is a schematic diagram showing a display with an example user interface.

FIG. 4 is a flow diagram depicting example computer executable instructions for a general process of automatic decision making.

FIG. 5 is a block diagram illustrating an example of automatic decision making in the medical field.

FIG. 6 is a flow diagram depicting example computer executable instructions for booking an appointment with a healthcare professional.

FIG. 7 is a flow diagram depicting example computer executable instructions for automatic decision making and reservation booking for restaurants or venues.

FIG. 8 is a block diagram illustrating an automatic decision making system for controlling television media.

FIG. 9 is a flow diagram depicting example computer executable instructions for automatic decision making for recording television content.

FIG. 10 is a flow diagram depicting example computer executable instructions for automatic decision making for watching television.

FIG. 11 is a flow diagram depicting example computer executable instructions for automatic decision making and purchasing of flowers or gifts.

FIG. 12 is a flow diagram depicting example computer executable instructions for automatic decision making and purchasing for Internet retail.

FIG. 13 is a flow diagram depicting example computer executable instructions for automatic decision making and purchasing of an event ticket.

FIG. 14 is a block diagram illustrating an example of an automatic decision making system for a vehicle.

FIG. 15 is a flow diagram depicting example computer executable instructions for automatic decision making, as well as navigation and control of a vehicle.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is recognized that people have busy lives and schedules, and that simple tasks still take time for a user to review and decide upon. The review and decision making process for a user is sometimes made even more difficult with the large amount of data available to a user.

For example, with the massive amount of products and services available to a user in today's global market, consumers may become overloaded and, sometimes, paralyzed with the abundance of possible choices and decisions. It is recognized that some software systems push recommendations to a user for their consideration. However, it is herein recognized that pushing recommendations to a user does not effectively solve the problem of saving time and mental effort for a user to purchase a product or service.

It is recognized that, more generally, current systems that provide recommendations and suggestions for making a purchase, or making a booking, or taking some other real-world action, engages a person directly in the decision-making process. This still places cognitive stress on the person and requires the person to spend time to make a decision.

It is also herein recognized that when a decision is inconvenient, tedious, time consuming, lacks urgency, or simply does not require an immediate response, people tend to delay or put off making the decision. This may cause people to forget to make certain decisions, or in some cases people may spend too much thinking about a decision. This can be inconvenient in some aspects of life, such as making a purchase. For example, if a user decides to make a purchase after a sale has finished, the user will miss the cost savings of the sale. In other cases, such as in medical and health applications, the delay in making a decision or, making a poor decision, can lead to serious health consequences for the person. For example, delaying a decision to schedule a health examination appointment can allow an illness to go undetected for a longer period of time, thereby causing more health damage to the person.

It is also herein recognized that the current computing systems of many organizations and companies do not effectively collect and process user data to help people decide on taking an action, such as making a booking or making a purchase. For example, pertinent types of data are not obtained and the collected data is not effectively used to provide a confident understanding of the user's desires. Therefore, computing systems wait for feedback from the user in order to confirm the user's desires, before taking action for the user. As such, waiting for feedback from a user often slows down the organization's or the company's operations.

The computing systems and methods proposed herein attempt to automatically assist in the decision making process and carrying out a related action for a person or party. In particular, the proposed systems and methods are configured to, for example, understand the desires of a person; when a person has such desires; and, to take action to fulfill such desires.

In an example, a proposed system is configured to automatically determine that a medical or healthcare-related appointment is required for a patient, determine an appropriate time for an appointment for the patient and the healthcare professional, automatically book the appointment, and advise the patient and the healthcare professional that the appointment has been booked.

In another example embodiment, a proposed system is configured to automatically determine at which restaurants a person is interested to eat, determine an appropriately timed reservation for the person, automatically book the reservation for the person, and after advise the person that the reservation for the restaurant has been made.

Other examples of proposed systems are also described herein for automatically deciding on a product or service to purchase, and automatically making such a purchase.

It will be appreciated that by using the proposed computing systems and associated methods, decisions and real-world actions can be automatically performed on behalf of a person or a party. This saves the person or the party time and cognitive energy.

In particular, the proposed computing systems and methods automatically recommend and decide to implement real-world actions on behalf of a person or a party. The decision to implement the real-world actions are made based on available user data and within user-established limits or tolerances, but without requiring the user to initiate the action. In other words, although there may be some initial parameters provided by the user, in general, no user input is needed to take action.

In an example aspect, a person does not need to ask for a real-world action to be done, or provide authorization or confirmation, and yet the proposed systems and methods will automatically take action to implement the real-world action.

In general, a real-world action herein refers to an action that has consequences in the physical world. Non-limiting examples of real-world actions include any one or more of: making an appointment, making a reservation, making a purchase, recording television media for future viewing, and making navigation control commands to operate the vehicle. It is appreciated that when an appointment or reservation is made, a person attends the appointment or reservation. It is appreciated that when a purchase is made, money is paid and a product or service is given to the person. It is appreciated that when a movie or television show is selected for viewing, the display screen will display the selected media and will not display other media.

In another example aspect, the proposed systems and methods are configured to adapt to a person's interests, schedules, and desires over time. For example, the system is able to learn over time. In a more detailed example, the system bases future actions, decisions, or recommendations on a person's response to a previous action, a previous decision, or a previous recommendation. The actions, decisions or recommendations may also be made based on external factors.

It is also herein recognized that many computing systems offer very specific solutions to a user query, once prompted by the user. It is also herein recognized that many of the computing systems with some automation capability are configured to primarily carry out very well-defined specific tasks that users want to be done repetitively. These computing systems, however, are not configured to carry out more complicated tasks that deal with a greater amount of uncertainty. These computing systems also do not typically collect user data in an ongoing manner, and are not integrated with vendors for which the user seeks goods and services.

The proposed systems and methods automate decisions and real-world actions. For example, a real-world action is created by a first decision (e.g. what action is to be automated?), and actioned by a second decision (e.g. should the system proceed to perform the action?). Other example computing operations involved in this process include gathering data to answers for questions like: “How?”, “When?”, “Where”, and for “Who”? Such data is used to create an action that is appropriate and likely to be desired by a person.

In a further aspect of the proposed systems and methods, such data is used to automate the decisions in a continuous and iterative manner. This leads to an automation principle of “doing without asking” in fields that typically require user input and authorization.

For example, the proposed systems and methods can provide an answer to an unprompted query, before receiving the actual query.

It is also herein recognized that organizations and companies typically require user input to perform an action (e.g. booking, purchase, etc.) in order to reduce risk and liability to the organizations and companies.

To address such risk, the proposed systems and methods provide tolerance levels that can be controlled by a user and by an organization or company. Moreover, the proposed systems and methods include obtaining data about the user and other users similar to the user, using the data to estimate the likelihood and degree of satisfaction of performing a real-world action, and estimating the feasibility of the real-world action, for example, for a determined time period.

Example operations of the proposed systems and methods include the following. 1) Collect or process data, or both, about parties or users for which the system will be taking an action. 2) Search and recommend possible decisions, using that data to make a recommendation for an action, and determine if that recommendation is within set tolerances. 3) Automatically process, validate, and take that action if the recommended action is within tolerance. If the recommended action is not within tolerance, send a recommendation to the parties or users for permission. 4) Obtain and process feedback based on response to automated action or recommendation, and use the feedback to update the decision making process for future searches and recommendations.

It is recognized that many systems require a user to make a decision and select a real-world action for each event, purchase, etc., without regard for the complexity or tolerated complexity of the real-world action.

In the proposed systems and methods, by not requiring any user input to make a decision and take action on behalf of a person, the user's time and energy can be saved. For example, a user no longer needs to review recommendations and to make a decision, because the decision and related action are instead automatically implemented. Furthermore, by determining if recommended actions are beyond tolerance parameters, a user is exposed to the more critical decisions and the more critical actions. Meanwhile, the simpler decisions and actions that are within the tolerance parameters are automatically acted upon. This can lead to cost and time savings, decisiveness, accuracy in taking timely and effective actions, and to other benefits, including those related to health and finance.

The feedback can be used to improve tolerances for both users and goods and services providers, so that the systems and methods can become more robust over time. In particular, as the amount of relevant information increases, the relevant information is used to make increasingly complex decisions and actions to the mutual satisfaction of the users and the organizations and companies acting on behalf of the users.

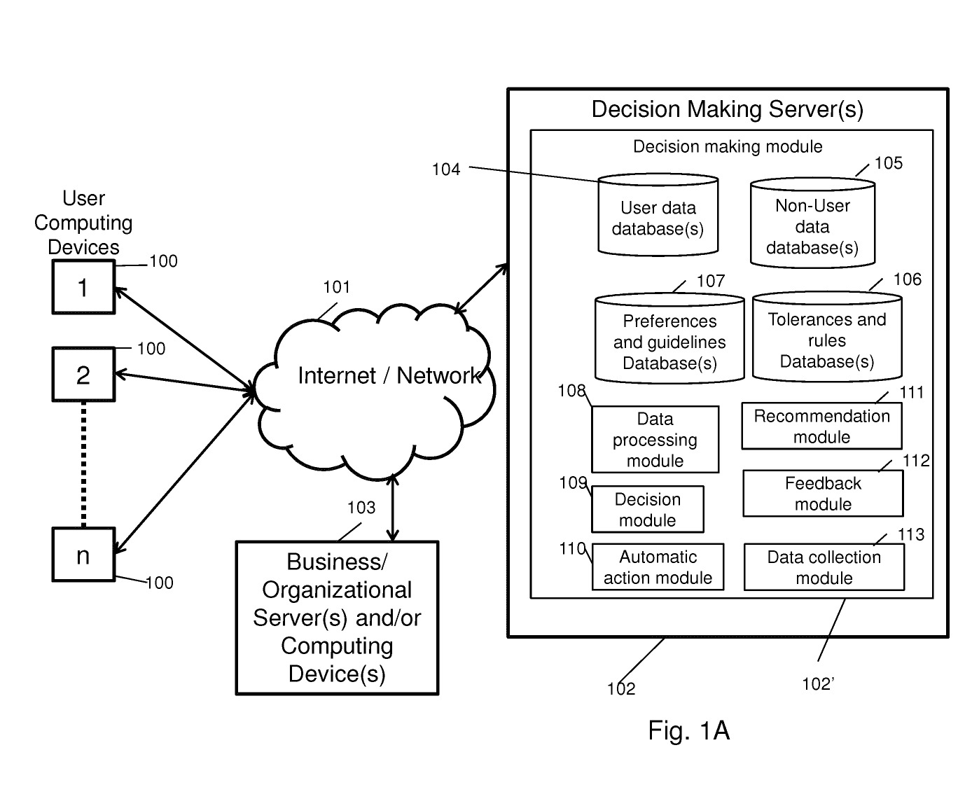

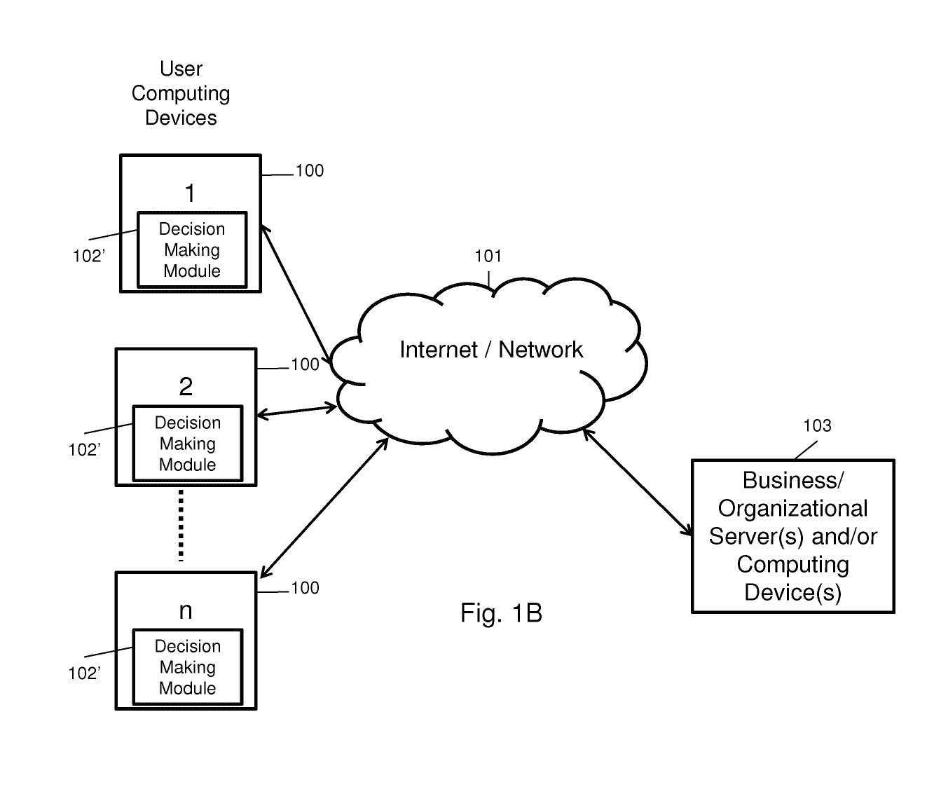

Turning to FIG. 1A, an example embodiment of a system is provided for automatically making a recommendation and carrying out a real-world action based on the recommendation. One or more computing devices 100 belonging to a user or to multiple users are shown. Examples of computing devices include mobile devices, cellular phones, smart phones, tablets, personal digital assistants, e-readers, notebook computers, laptops, desktop computers, wearable computing devices, GPS devices, and the like.

The system also includes one or more decision making servers 102. The decision making server is configured to obtain data about a user and obtain data from other sources, applying decision making algorithms to generate a recommended real-world action, and to carry out the implementation of the action when the action is within tolerances. A decision making engine or a decision making module 102′ resides on the decision making server 102. In another embodiment, the various modules and databases shown in decision making servers 102 could each reside on their own collection of servers, or in various combinations of arrangements conceivable to those skilled in the art.

The decision making module 102′ also includes or has access to databases to store various types of data. For example, there is a user data database 104 that stores and organizes data about a user. A non-user data database 105 stores data about the partner organization or company, or other factors that are not specific to the user. A preferences and guidelines database 107 includes data about the preferences and the guidelines of the user and the preferences and guidelines of the partner organization or company. The preferences and guidelines data is derived from the data stored in databases 104 and 105. A tolerances and rules database 106 includes tolerances and rules set from the user's perspective and tolerances and rules set from the partner organization's or company's perspective. These tolerances and rules are derived from the data stored in databases 104 and 105.

The decision making module 102′ also includes a data collection module 113 that is configured to obtain data and store the data in the databases 104 and 105. The data processing module 108 is configured to process the collected data in database 104 and 105 to derive the preferences and guidelines (e.g. stored in database 107), derive the tolerances and rules (e.g. stored in database 106), derive or identify features that may be correlated to potential actions, and identify, quantify, categorize, and/or label the set of possible actions that may be carried out. As an example, a feature represents an input variable, explanatory variable, control variable, predictor, covariate, or data characteristic that may be used to predict an outcome or action. Other examples of features, also referred to as data characteristics, include an amount paid for a product or service, a location of a restaurant, and a scheduled time for an appointment. It will be appreciated that other features or characteristics of the collected data can be used to identify possible actions.

The decision module 109 is configured to generate one or more recommended actions using the potential actions and other data derived by the data processing module 108. The decision module 109 is also configured to determine if a recommended action is to be automatically performed or recommended, based on tolerances. The automatic action module 110 is configured to automatically perform the recommended action, or initiates the performance of an automatic action. The recommendation module 111 is configured to send a recommended action to a user. The feedback module 112 is configured to obtain implicit or explicit feedback, or both, from the user about the automatically performed action or the recommended action.

The system also includes one or more business or organizational servers, or other types of computing devices 103. These computing devices are configured to make available or send data, which may be relevant to the decision making process, to the decision making server 102. The server or computing device 103 may also receive commands from the decision making server 102 to perform a real-world action. The server or computing device 103 may also receive notification from the decision making server 102 that a real-world action was performed on behalf of the user.

It will be appreciated that a partner organization or a company is one that is partnered with a user, such that an automated decision and action is made on behalf of the user involving the partner organization or company. A partner organization or company may be herein interchangeably referred to as a “partner” or “vendor”. The business or organizational servers, or computing devices 103 are interchangeably herein referred to as a “partner server””, “partner module”, “vendor server”, or “vendor module”.

The user computing device(s) 100, the decision making server(s) 102 and the business/organizational server(s) or computing device(s) 103 are configured to be in data communication with each other over the Internet or another type of network. It can be appreciated that the network may be wired or wireless, or a combination of both types of technology.

The network 101 is a path of data across which multiple devices may communicate. The network may be wired or wireless, and may have any number of configurations (e.g. star, ring, bus, etc.) known to those skilled in the art. The network may comprise a wide area network (WAN), a local area network (LAN), (e.g., the Internet), a peer-to-peer network, Bluetooth, cellular, and/or any other interconnected data path. The method for sending and receiving data may be over a communication/network protocol such as transmission control protocol/internet protocol (TCP/IP), short messaging service (SMS), multimedia messaging service (MMS), WAP, email, etc. Other currently known and future known communication protocols can be used according to the principles described herein.

The computing devices 100, 102, and 103 each include a processor, a memory device, and a communication device. The communication device is configured to send data over the network 101. Some devices, including the user computing devices, are equipped with user interface devices. Examples of user interface devices include a display screen, a touch-sensitive display screen, buttons, a keypad, a mouse, a keyboard, a camera, a GPS, a microphone, etc.

In an example embodiment, not shown, the functionality of the decision making server 102 and the business or organizational server 103 are combined into a single server system.

The configuration of FIG. 1A is an example embodiment. Any permutations or combinations, or both, of this functionality may be handled by either the decision making servers, or the partner servers. There may, for example, be no decision making server, as the logic may entirely reside with the partner server. Similarly, for example there may not be any partner server, because the entire functionality of the partner server resides within the decision making server. In the latter case, the partner servers may permit the access of the data from their data stores to the decision making servers.

It can also be appreciated that although a single server may be mentioned, a server may refer to a server system that includes several servers networked together.

Turning to FIG. 1B, another example embodiment of a system is provided which includes user computing devices 100, the network 101, and the partner server(s) or computing device(s), or both 103. In this example, a user computing device 100 includes a decision making module 102′. It is appreciated that the decision making module 102′ may be a local software or application that runs on the user computing device 100. In an example embodiment, all of the functions of the decision making server 102 are performed by the decision making module 102′, so that a decision making server 102 is not required, as shown in FIG. 1B. In another example embodiment, some of the functions of the decision making server 102 are performed by the decision making module 102′, so that the decision making server 102 (not shown in FIG. 1B) and the decision making module 102′ communicate with each other to perform the proposed methods.

The operations described herein can use different computing configurations other than the configurations described herein. More generally, the terms “decision making server” and “decision making module” are interchangeably used.

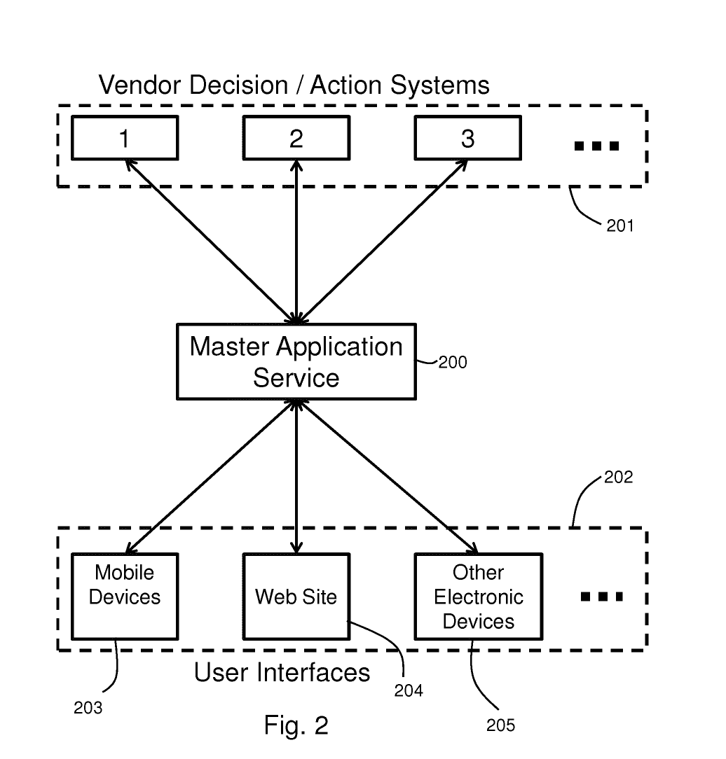

Turning to FIG. 2, another example embodiment of a system is provided for automatically making a recommendation and performing a real-world action based on the recommendation.

The system includes a master application service module 200 that allows a user to control various parameters of the recommendation and action process. The module 200 may be implemented as a separate server, or may be integrated into decision making and action systems 201. Where the module 200 is a separate server, it also includes a processor, a memory device and a communication device. The decision making and action systems 201 function like the servers 102 and 103, for example.

User interfaces 202 are provided to allow a user to interact with the master application service module 200. Examples of user interfaces include mobile devices 203, web sites 204, and other electronic devices 205.

It is appreciated that the devices and modules 200, 201 and 202 are configured to communicate with each other through the Internet, wired networks, or wireless networks, or combinations thereof.

The module 200 is configured to authenticate user login credentials, as well as check and validate that permissions for the user and member organizations and/or companies are active. The module 200 is also configured to provide a consolidated interface for making recommendations and carrying out actions based on the same. In another example, the module 200 also provides a history or record of the decisions made and actions performed. The module 200 is also configured to provide notifications to one or more computing devices connected to the module. In another example, the module 200 also is configured to receive inputs from users, organizations, or companies, or combinations thereof, to modify tolerance parameters, preferences, and permissions.

In another example aspect, the module 200 is configured to be a control hub. In other words, the module 200 has the functionality of a check-pointer, or gatekeeper, or permissions dashboard, or combinations thereof.

In another example aspect, the module 200 provides access to third-party partner websites, for example, via links, advertisements, and buttons.

In another example aspect, the module 200 provides a graphical user interface to allow a user to view other partners that support automated decision making. This improves exposure to users about goods and services providers that are compatible with the proposed systems and methods.

In another example aspect, the module 200 controls access of the automated decision making process to 3rd party partner websites. For example, an “on/off” switch or control is provided that allows a user to place the decision making system in a fully-automated mode to automatically perform real-world actions based on computer-determined recommendations (e.g. “on” mode). The master application service 200 is configured to receive a user input with respect to the “on/off” control to place the decision making system into a recommendation only mode, where recommended actions are provided to the user and the real-world actions are not performed until a user provides authorization or consent (e.g. “off” mode). Based on a user input, the “on/off” control modes may be applied to all organizations or companies that are interacting with the user, or may be only applied to certain selected organizations or companies that are interacting with the user. In this way, the user can easily disable and enable the automated functionality.

In another example aspect, the module 200 is used to monitor or control universal thresholds, also referred herein as tolerances. For example, a monthly budget tolerance is provided to make automated purchases that do not, in total, exceed $X. After the tolerance has been met (e.g. $X has been spent, or a recommended purchase will exceed the tolerance budget of $X), then all subsequent recommended purchases are not automatically acted upon. Instead, these recommended purchases may be sent to the user as a recommendation for the user's consent or authorization. A user can use the module 200 to input one or more tolerance parameters, such as a total budget amount $X. This aspect may be considered to assist users to be better disciplined with their spending habits if recurring or discretionary expenses are restricted to a monthly tolerance.

In another example aspect, the module 200 is used to track actions that have been automatically performed or recommended, or both. This allows a user to view the history of automated actions. For example, the module 200 can aggregate data to track key metrics, royalties, total dollar value actioned, frequency, the number of users, trends in acceptance and satisfaction, etc.

In another example aspect, the module 200 is configured to display profile information about a user, such as their location, name, age, preferences, etc.

In another example aspect, the module 200 provides a user interface to receive contact information about other potential users, and can send information to the other potential users to use the proposed systems and methods described herein. In this way, a user is able to easily refer friends or contacts to use the proposed systems and methods described herein. The module 200 also can send information about a user's preferred partner organizations or companies to the potential users or to other current users. In this way, after receiving the information from the module 200, the potential users or other current users will have the option to conveniently select the user's preferred partner organizations or companies as their own partner organizations and companies.

The module 200 may also allow a user to track any rewards or loyalty points earned via use of the proposed systems and methods, or earned via any partner organizations or companies.

It is appreciated that in example embodiments without the presence of a master application service module 200, users and organizations or companies are still able to communicate with each other. It is also appreciated that, in other example embodiments, the master application service module 200 is not required to obtain data about a user; obtain data about a partner organization; process the data about the user and the partner organization to recommend the real-world action and to generate a tolerance rule; when the real-world action is within the tolerance rule, automatically perform the real-world action for the user and in collaboration with the partner organization; and when the real-world action is not within the tolerance rule, provide a notification to the user recommending the real-world action be performed.

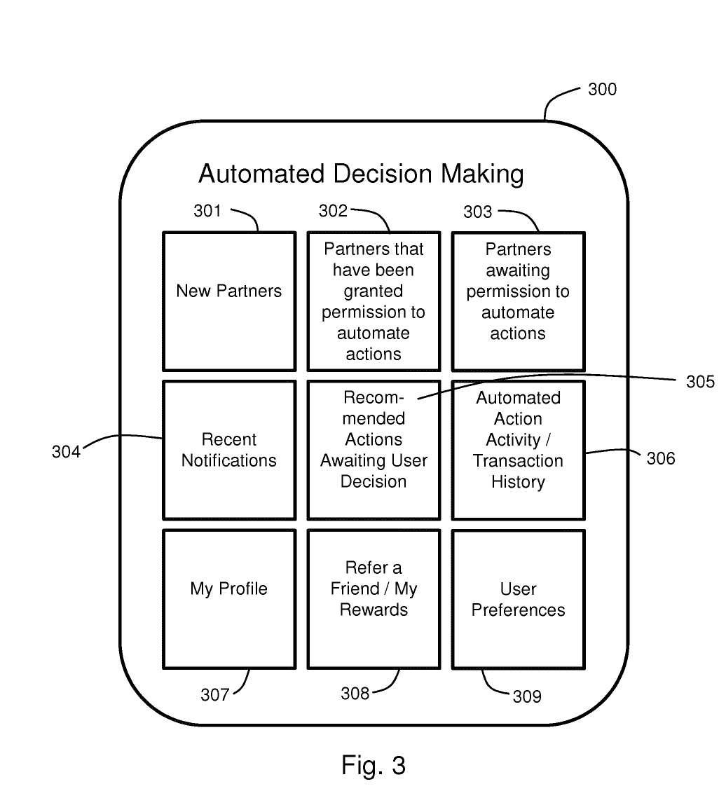

Turning to FIG. 3, an example embodiment of a graphical user interface 300 displayed by the module 200 is provided. It includes multiple “buttons” to launch user interfaces, each having different functions. For example, button 301 is used to initiate the display of an interface related to searching for and viewing new partner organizations or companies. Button 302 is provided to initiate the display of an interface related to viewing and modifying relationships with partners that have been already granted permission to automate actions. Button 303 is provided to initiate the display of an interface related to viewing and modifying relationships with partners that are awaiting permission to automate actions. Button 304 is provided to initiate the display of an interface for viewing recent notifications. Notifications may include actions that were recently performed, and the interface may include controls for the user to reverse or modify the automated action (e.g. make a cancellation, re-schedule an event or appointment, make a return of a product, select a different mailing address for a shipped product, select a different color or size of the product, etc.).

Button 305 is provided to initiate the display of an interface for viewing and interacting with recommended actions that are awaiting a user's decision (e.g. authorization or dismissal of recommended action). Button 306 is provided to initiate the display of an interface for viewing and interacting with automated action history, as well as recommended action history. Button 307 is provided to initiate the display of an interface for viewing a user's profile. Button 308 is provided to initiate the display of an interface for referring contacts and viewing rewards. Button 309 is provided to initiate the display of an interface for viewing and modifying user preferences, which include tolerances set by the user.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing devices, servers, or modules described herein, or accessible or connectable hereto. Any application or module herein described may be implemented using computer readable/executable instructions or operations that may be stored or otherwise held by such computer readable media.

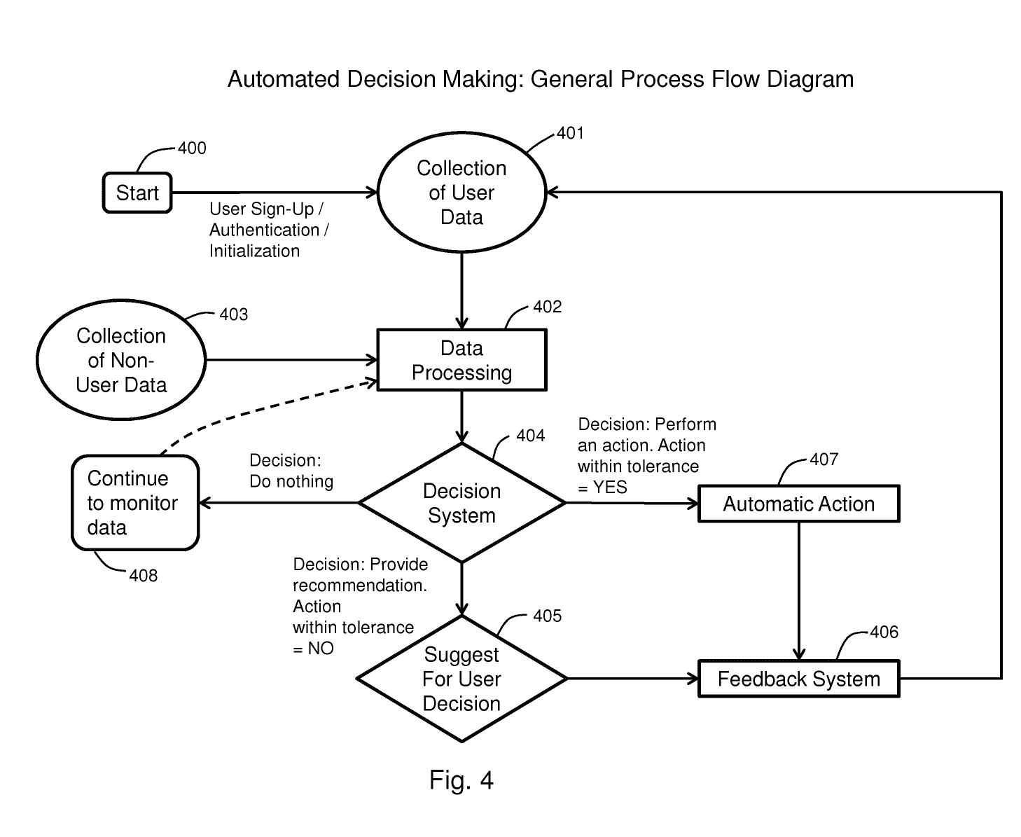

Turning to FIG. 4, example embodiment computer executable instructions are provided for automatically determining a recommended real-world action and automatically performing the real-world action. These instructions, for example, are performed by a decision making server 102.

The process, for example, starts at block 400. There may be a one-time initialization of the system specific to a given user. The initialization may include a sign-up or authentication process, or both. For example, an interface is provided to facilitate users to sign-up, activate the service, opt-in/out of the service, agree to the terms and conditions of the service, etc. This initialization operation can be completed in a plurality of ways, including but not limited to signing up via a centralized application, or via individual goods and services portals (e.g. a GUI portal managed by a partner organization or company).

The initialization process may also include granting the decision making server with permission to access a user's personal information and applications. For example, the user's personal information and applications include any one or more of a calendar application or information, banking information, credit card information, an email address of the user, a telephone number to send text messages, instant messaging contact information of the user, medical information, insurance information, GPS or other location information based on a user's computing device, etc.

The initialization process may also include obtaining the user's tolerances. For example, the user is presented with a GUI to input the tolerances.

During or after the initialization process, if initial tolerance levels have been set to default values by the decision making server, then a user will have the option to modify the tolerance level to a customized value.

In an example embodiment, the system would initialize the decision processes for users according to some schedule or event (daily, on special occasions, every 3rd Tuesday of the month, every time new user or vendor data becomes available, etc.). This frequency could be determined by constraints specified by both users and partners.

As an example of an event that could initiate the automated decision making process, after recognizing that the user has made one purchase, the system automatically purchases an additional item both suitable to the user, and complements their purchase. For example, a person buys flowers for Valentine's Day, and the system automatically adds a suitable Valentine's Day card to their order.

It is appreciated that, in a preferred example embodiment, the process of computing tolerance levels and preferences is repeated as more information is obtained by the system. For example, more information is obtained with each iteration of the process in FIG. 4.

When the initialization process is complete for the user, the process proceeds to block 401, which implements the collection of user data. It is appreciated that the decision making server includes a data collection module that acquires user data. The acquisition of data may be ongoing as new data about the user becomes available. The data collection module receives user data from various sources (e.g. licensed service providers and partners), as well as inputs from the user. In an example embodiment, user data can include data on other users related to the given user (e.g. spouse of the user, children of the user, family members of the user, co-workers of the user, friends of the user, etc.) to formulate preferences, “smart” gift lists, etc.

For example, if the user's spouse has an active profile with the decision making server, the user's spouse's data can be collected (e.g. spouse's Amazon.com's wish list) and can be used to “smartly” action items for purchasing items for the user's spouse as a gift, or for their household or their children.

In an example embodiment, all the user data is collected automatically without the user's interaction or input, other than the initial permission provided during the initialization stage. In an example embodiment, user interfaces are provided by the decision making server to obtain some user input.

Non-limiting example embodiments of user data that is obtained includes: demographic data; location (e.g. mailing/billing address); billing method; credit card information; purchase history; calendar data; medical data; links to other data sources and contacts (e.g. via social networking platforms and contact lists like Twitter, LinkedIn, Facebook, Pinterest, etc.); and preferences. Preferences may be derived from various applications used by the user. Examples of preferences include brand, quality, quantity, price, color, retailer, type of food, type of entertainment, preferred authors, preferred genres of books and literature, language, etc. One or more of the preferences may be also set as a filter status, to exclude actions that do not meet the one or more preferences. In many cases, there exist Application Programming Interfaces (APIs) for accessing user data from third party sources. This data could be queried, and the results could be stored during the data collection process. This may require that the user both provides access to, and authorizes, the system to obtain this data. For example, Facebook allows a user's “Likes”, as well as all pages liked by any of that person's friends, to be queried using their “Graph” API.

The user data is stored and updated as new data about the user is made available. For example, new data about the user is made available when the user provides feedback about a real-world action that was performed or recommended, or other user input. The feedback may be explicitly provided or implicitly provided by the user.

At block 403, the decision making server also includes a module to collect data that is not specific to the user. This process is also ongoing and is updated as new data becomes available. For example, the decision making server uses the given user's data to identify other users or a user group that is similar to the given user. For example, the other users are located in the same region as the given user; or are of the same gender and age group; or are of the same marital status; or are of the same field of work; or are of the same income level; or are of the same race; or are of the same religion; or of the same social groups; etc. The non-user specific data about the other users or the user group is collected to make generalizations that are likely to be applicable to the given user.

In another example, the data non-specific to the user may also include data specific to a partner organization or company. This could include information such as employee schedules, inventory, operational requirements, product catalogs, etc.

In another example, the data non-specific to the user may also include third party sources such as special occasions, weather, product trends, disease trends, publications, legislature, government census, spatial demographics, etc.

The data collected at block 403 may also be used to set tolerance levels from the perspective of the system, or a partner organization or company. In addition or in the alternative, the data collected at block 403 is also used to set default tolerance levels from the perspective of the given user. For example, if on average, other users have a tolerance level of spending $Z a month or making R number of reservations a year (e.g. based on the average, the maximum, the minimum, the median, etc.), then the computed tolerance level from the other users is used as a default tolerance level for the given user. This is an example of using the features or characteristics of the collected data to compute a tolerance level.

In another example embodiment, if the tolerance level set by a partner is provided, then the more restrictive of the tolerances between the partner and the given user is used.

Continuing with block 403, the non-user collection data module compiles entity- and non-entity specific data and/or guidelines. Examples include, but are not limited to, average ticket price; average spend in customer's demographic/location; inventory/time availability; region-specific customs and traditions; popular trends; weather conditions; sport events; political events; seasonality and special occasions (e.g. Valentine's Day, birthdays, anniversaries, Christmas, Black Friday, etc.).

In an example embodiment, the determination and computation of tolerance levels may take place during the data processing operation 402. In particular, the data collected and stored during blocks 401 and 403 are processed or used by a data processing module. In particular, the data processing module processes the data, defines and categorizes the data for use, and is further configured to compute additional information from the data, such as tolerances and preferences, and other data characteristics that may correlate with potential actions. The data processing module 402 may also identify, quantify, categorize, and/or label what features of the data represent actions.

Continuing with block 402, the data processing module is configured to perform various functions. An example function is cleaning of data, which includes removing bad characters, fixing typos, imputing missing data, etc. Another example function is validation, which includes checking data quality, and identifying outliers/bad measurements. Another example function is merging, which includes combining multiple data sources together into a single source.

Another example function is normalization, which includes ensuring data has a common reference (in space and time for example). Another example function is transformation, which includes applying mathematical transforms to create derived data. For example, the data processing module is configured to infer a parameter that is not directly measured. In a data specific example, an individual's discretionary income is inferred based not on explicit data on a tax return, but based on the individual's amount and type of historical spending. For example, if historical spending data reveals that the given user has spent $X on travel and discretionary items (e.g. not regular bills, not grocery and gas or other necessary expenditures), then the data processing module determines that the given user has $X of available discretionary income. It is appreciated that machine learning could be used to create derived data. This is an example of the features or characteristics of the collected data.

Another example function of the data processing module is aggregation, which includes generating data summary statistics based on samples of the data.

The data processing module is also configured to define and categorize data for certain use. Non-limiting example categories and types of data are provided below:
Demographic data: age, location, gender, race, etc.
Purchase history data: price, quantity, quality, date of purchase, frequency
Calendar data: birthdays of other contacts, other contact's relationship to the given user (e.g. derived from social networking platforms), special events (e.g. anniversary)
Category (health, dining, entertainment, shopping, etc.)
Demographic data compared to health guidelines
Average spend per visit, average ticketed item, etc.
Days off, preferred days/nights (e.g. Tuesday matinee at a partner company, super saving Sundays at a partner company)
Repeat events (guys night out, Friday night clubbing, date night, etc.)
Special occasions, birthdays, holidays, anniversaries, etc.
Recurring payments (groceries, prescription medication, vices (cigarettes), etc.)
Preferences for movies by Disney
Disney movies categorized under “Movies->Family”

Another example function of the data processing operation 402 could be to set system tolerances. For example, the decision making server or module could verify if sufficient data is available to immediately make a decision for a user (e.g. strictly demographics based as is the case for the preventative health care guidelines). A decision can only be made as soon as the required data is provided by the user. In some cases, this user data may already exist and be available through a partner's database, so decisions can be made immediately for users, without receiving any additional information inputted by the user.

Another example of the data processing operation 402 that includes setting system tolerances is the case where a decision requires a number of historical actions to occur. These historical actions related to the user may be obtained by searching databases of the relevant partners.

In another example, such as in a flower or gift delivery e-commerce application, a purchasing decision can be made by drawing a conclusion from as little as one observation (e.g. a user purchased flowers on Valentine's Day last year).

Another example function of the data processing operation 402 includes using the past actions made by the user (e.g. as obtained by a partner server) to compute a feature or tolerance level for making an action. For example, if the user historically spent on average $Y per month on a certain product or service, the decision making server will initially set the tolerance level to automatically make purchases up to the total limit of $Y per month for the same or similar type of certain product or service. In another example embodiment, a fraction of the average spending total is computed and established as the tolerance. For example, if an average of $Y per month was spent on a product, then the tolerance level to make automatic purchases without the user's knowledge or input is 75% of $Y per month, or some other percentage. In this way, a more conservative tolerance is automatically provided, and automatic actions are not made which may be undesirable to the user.

Another example of tolerances or features that may be computed by data processing module 402 are those based on historical actions made by the user including timing of events, types of products, types of services, locations of events, etc. For example, based on historical actions that were all made during a certain time of day, or during a certain day of the week, all future automated actions (e.g. making appointments or reservations) for similar actions must be made within the same time period of a day or the same day of the week. The automatically computed tolerance value may be used as a default tolerance value.

In another example embodiment of automatically setting a tolerance, based on identifying that the majority of venues (e.g. restaurants, doctor appointments, concerts, service providers, etc.) that have been engaged by a user are located within a certain distance from the user's home or work address (or both), the decision making server will initially set a tolerance default value to be within the same certain distance for future automated actions involving venues. Alternatively, the decision making server will set a distance tolerance default value that is a fraction of the determined certain distance. For example, based on historical data, the certain distance is determined to be (e.g. using the average, median, maximum, minimum, etc.) N kilometers, then the tolerance is set to 75% of N kilometers or some other percentage.

The data processing computations used to identify, quantify, categorize, and/or label features, actions, correlations, or relationships, establish preferences, and establish tolerances may use heuristics, pattern recognition, statistical analysis, mathematical modelling, optimization, or machine learning, or combinations thereof.

Following data processing module 402, the process proceeds to decision system 404 where recommended action(s) are obtained. If the recommended action is within tolerance, the process proceeds to performing the real-world action according to the recommendation (block 407). If the recommended action is not within tolerance, then the process proceeds to sending a recommendation to the user for consent or authorization (block 405).

If no recommendation is made, no action is taken at the time and the data continues to be monitored (block 408). The process from block 408 continues with the data processing at block 402. In other words, as more data becomes available by blocks 401 or 403, or both, new data may initiate the data processing again (block 402) and the decision making process again (block 404). In other words, the process shown in FIG. 4 can iterate many times.

Continuing with block 404, the decision making module is configured to estimate an unknown quantity (e.g. what action should be performed?) from known (or derived) quantities and constraints. For example, both the known and unknown quantities may be binary, categorical, or continuous. The estimation may be computed using machine learning or other estimation algorithms or techniques known to those skilled in the art.

Example of unknown quantities for an e-commerce example includes a binary type determination (e.g. Should the system automatically purchase the third novel in a popular series for the given user?). An example of an unknown quantity for e-commerce example includes a continuous type determination (e.g. When should the system automatically purchase a science fiction novel for the given user?). An example of an unknown quantity for an e-commerce example includes a categorical determination (e.g. What science fiction novel should the system automatically purchase for the given user?).

In an example embodiment, the decision process uses a hierarchical model. The decision process will determine, for example, when, what, and if a book should be purchased for the given user.

An example embodiment includes a machine-generated query that automatically searches and compares the item(s) to be automatically actioned (e.g. purchased) using the product SKU, bar code, etc. to all identical items available on all partner portals to identify best execution (e.g. best price, best time, etc.). From this example, the concept implies that the system is not limited to the single user/single partner scenario, but may be trivially extended to the multi-user/multi-partner case.

To determine a recommendation for a user, a potential strategy that may be utilized is to identify users that are similar to the user of interest by clustering their likes, dislikes, preferences, demographics, habits, transaction history (purchases, bookings), items they have viewed, etc. The types of data collection may be explicit (e.g. asking a user directly of their likes/dislikes), or implicit (e.g. using their transaction history). After identifying these clusters, the system can then consider alternatives for the given user based what other items are in the recommendation domain of the given user's same-cluster of users. This example may use unsupervised machine learning computations. Semi-supervised machine learning computation may analyze the clusters to determine their meaning.

The priority of the recommendations for a given user can be made by applying user, partner, and system specific tolerances (constraints) to the items in this domain. The tolerances can be required, or optional. The tolerances can be in the form of equalities, or inequalities. The tolerances can also be changed dynamically by defining customized heuristics by any of the user, the partner, and the system. This computation of the priority may also be determined using machine learning, which includes using data pertaining to both the user (e.g. likes, preferences, transaction history, etc.) and the non-user (e.g. partner inventories, product catalogs, time until a special occasion, etc.) as input to the priority computation.

In the case of a book purchasing example, the priority of purchasing a book for a user that is the third in a trilogy, after the user favourably rates the previous two books, would be likely higher than purchasing a book for a user that has been favourably reviewed by a large population of their cluster peers.

The action is also not limited to purchasing one book. For example, several books may be purchased simultaneously, if they satisfied the maximum single purchase spending constraint for the user.

It is also noted that clusters need not be mutually exclusive (e.g. the same users may be in more than one cluster).

In another example aspect, recommended actions can be made by both looking at: 1) outcomes, user preferences, and history (e.g. using content based filtering); and 2) similar cluster users (e.g. using collaborative filtering).

The following is a brief description of machine learning strategies that may be used by the decision making module.

Unsupervised machine learning includes clustering based on centroids, distributions (e.g. mixture models), or density. These methods may be used to figure out what users are similar, and how they relate to one another.

Supervised machine learning includes using algorithms such as decision trees, support vector machines, artificial neural networks, and/or ensemble methods. As an example of supervised machine learning, suppose labelled observations of action A (and/or not A) are available. The observations of A have corresponding user preferences X and Y, and vendor condition Z, then the decision making server or algorithm concludes that if a new observation contains X, Y and Z, then it should produce a recommendation for action A or automatically perform action A. In this example, X, Y and Z are conditions that may be quantitative or qualitative.

In an example embodiment of machine learning, a model is developed to express how inputs (e.g. features and conditions) lead to an action. To develop the model, the decision making module determines the clustering of people or users. Then the decision making module determines what the possible actions are. After, the decision making module labels what actions are best, given the inputs that are available. These labels may already exist, or human judgement is used to apply labels to the actions. The model is then built using the labelled actions and is applied to the clustered users.

It is appreciated that currently known and future known machine learning techniques are applicable to the principles described herein.

In an example embodiment, the output of the decision process is a prioritized list of outcomes. Every item in the list is mapped either to actions that the automatic action process is capable of carrying out, or recommendations that the automatic action process is capable of providing to a given user. Therefore, for example, each outcome has both an associated priority, and a state (either ‘action’ or ‘recommendation’). The decision system returns all feasible outcomes. There are system constraints that specify the priority threshold in which to return outcomes. If no satisfactory outcomes are provided, the assumed decision is to take “no action”. The decision making process would be re-initiated once an appropriate event has occurred, or as scheduled.

From block 404, if the system decides to automatically perform the recommended real-world action, the process continues to block 407.

At block 407, an automatic action module is configured to receive a request that contains a prioritized mutable list of possible outcomes from the decision process for a user.

In an example embodiment, multiple commands to perform actions for numerous users are generated and sent to the automatic action module, either simultaneously or in succession. In such a case, a prioritized queue of the action requests may be used to organize the actions. In this manner, those action requests with highest priority could be processed first. As an example, if there were many requests from many users sent to automatically purchase products from an online retailer, those requests sent by users specifying the earliest possible shipping date could be processed first.

In an example embodiment of the mutable or dynamic list, if a certain action in the list was at one point within tolerance, but has not yet been performed, and at a later point is no longer within tolerance, then that certain action will be deleted from the list. For example, the item for purchase becomes sold out when the request is processed by the action system. In this way, the list is mutable or dynamically updated.

If there are many requests, each of which with many possible outcomes, an embodiment of the action module may create a prioritized queue for processing all of the requests. A request herein refers to a collection of decisions for a specified user, at a specified point in time. The system could be processing multiple users at the same time, thus there could be a collection of requests for the action system to process. For example, there could be more than one decision that is suitable for a given set of inputs. The decision process will use a score to rank the decisions. It will return the possible decisions, and their score. It is possible that more than one decision can be acted upon. For example, when buying novels from an Internet retailer, the user specifies that his monthly allowance is $50. There could be multiple books that the system finds suitable for the user, and the system might purchase the best books that sum to a total cost of $50 or less.

The position of a particular request may be changed according to current/upcoming states of the system. For example, the processing of an action may not necessarily be instantaneous, and there may be a time delay between (1) the decision process sending a request and (2) the action process performing this request. As a result, the action module will also be validating the constraints associated with the outcomes of the request at the time of processing. This is to ensure that the constraints are still valid at the time of processing. If the constraints for an outcome are invalid, the action module will communicate with the decision process to update the outcomes.

Examples of automatic actions include scheduling, booking, buying, reserving, etc. and these automatic actions require no user interaction prior to submitting action to the service/action provider (e.g. partner organization server or partner company server).

It is appreciated that recommended actions include those actions that require user consent before action is sent to the service/action provider to perform the real-world action.

Continuing with FIG. 4, at block 405, a recommended real-world action is sent to the user (e.g. for viewing on the user's computing device).

At block 406, feedback is obtained, for example, directly from the user or derived from observing the user's response or lack of response. The feedback may be obtained as a result of block 405, or as a result of block 407.

For example, following block 405, when the user receives the recommended action, the decision making server may receive no input (e.g. the user ignores the recommendation); this may be considered as negative or neutral feedback. Or the server may receive an input to authorize the implementation of the real-world action; this may be considered positive feedback. Or the server may receive an input prohibiting the implementation of the real-world action; this may be considered negative feedback. Or the server may receive an input modifying the parameters of the real-world action and to authorize implementation of the modified real-world action; this may be considered positive feedback in general. The modified parameters would be considered preferences, when making future recommended actions.

The feedback system 406 may also assess the quality of recommendation/action based on user feedback (e.g. like/dislike, rating, etc.). Feedback can be interpreted as positive or negative, and may be rated on a scale.

For feedback following an automatic action that was already performed (e.g. following block 407), positive feedback is identified when the given user does not cancel the action (e.g. cancels appointment or returns purchase). A neutral feedback response is identified when the given user modifies the automatic action. A negative feedback response is identified when a user deletes or cancels the automatic action, or reverses the automatic action (e.g. refunds a purchase).

The user feedback is fed back into user parameters at block 401. The feedback provides labelled examples of actions, and are used to improve and control the decision-making process (e.g. preferences and tolerances of the user, quality of the decisions, etc.). For example, using the feedback, heuristics or machine learning, or other dynamic decision making processes, gradually become more accurate at predicting a user's decision profile. It will also be appreciated that there are multiple ways of achieving this feedback. For example, the feedback module is configured to compare an actual action vs. automatic/recommended action after the fact. For example, if a user dislikes an action, this feedback would then update the appropriateness of that action given the inputs at the specific point in time. This would provide a labelled example of an “incorrect” action, and vice versa. In order have a good estimate of the actions to perform, both “correct” and “incorrect” actions may be required. The “correctness” of the action may also be on a numerical or nominal scale, and not just binary (depending on how the data is collected during feedback).

It will be appreciated that the example provided with respect to FIG. 4 can be applied to different domains (e.g. healthcare, e-commerce, venue bookings, media viewing, vehicle navigation and control, etc.).

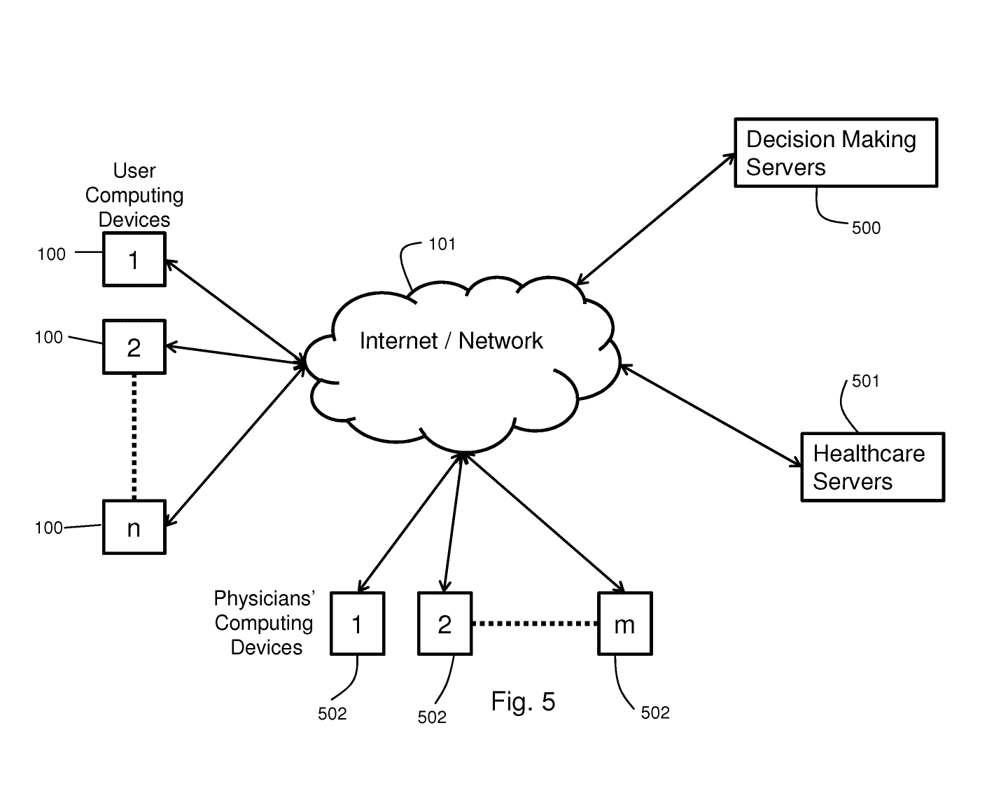

Turning to FIG. 5, an example healthcare computing system is shown for making automatic decisions in a healthcare application using similar principles as above. The automatic real-world actions include scheduling appointments for a patient and a healthcare professional, such as a physician. The real-world action may also include scheduling a healthcare examination or test, scheduling a healthcare procedure, and purchasing or ordering drugs or healthcare equipment (e.g. a cast, a brace, crutches, a pin for orthopedic surgery, a diabetes testing device, a pacemaker, a hearing aid, a battery for a hearing aid, etc.).

In FIG. 5, the system includes decision making server(s) 500, one or more user computing devices 100, healthcare server(s) 501, and computing devices belonging to healthcare professionals 502. These servers and devices are in data communication with each other over the Internet or a network 101. The decision making server 500 may include the decision making module 102′.

The healthcare server 501 may be operated by one or more healthcare organizations or companies, such as a family practice, a walk-in clinic, a specialist's office, a hospital, a pharmacy, an eye-care clinic, a hearing-aid clinic, a family planning clinic, a physical therapy clinic, a chiropractor clinic, a healthcare product supplier, etc., or even by the patient(s) themselves. The healthcare server 501 is configured to perform real-world actions, such as those mentioned above. The healthcare server may also be configured to provide data about a given user (e.g. for block 401) and to provide data that is not specific to a user (e.g. for block 403). The health care server may, for example, have stored thereon electronic healthcare history for the given user, which is configured to be accessible to the decision making server 500. For example, the healthcare server can provide healthcare rules and guidelines to the decision making server 500 to assist in the decision making process. In particular, healthcare rules and guidelines can be used to establish tolerances and preferences for the decision making process. The healthcare server can also provide data about other users similar to the given user or patient.

The one or more computing devices 502 belonging to healthcare professionals include desktop computers, mobile devices, tablets, phone systems, etc. These computing devices 502 may be used by the healthcare professional directly or by their staff members (e.g. administrators or assistants). Data from the computing devices 502 is accessible to the decision making server 500. Examples of data from the computing devices 502 that can be accessed by the server 500 include: calendar schedule of a healthcare professional, location of the healthcare professional, services of a healthcare professional, language(s) spoken by the healthcare professional, cost for services provided by the healthcare professional, and other information about the healthcare professional's services.

Data is also sent from the decision making server 500 to the one or more computing devices 502. The data sent from the decision making server 500 includes, for example, appointment bookings, examination bookings, ordered tests, ordered healthcare products, etc.

A user's or a patient's computing device 100 may be used to automatically provide data about the user (e.g. location, calendar availability, time zone, etc.). In some example embodiments, the computing device is healthcare related and is in data communication with a physiological sensor, or includes an integrated physiological sensor. Examples of such physiological sensors include: electrocardiography sensors, sensors that measure strength, sensors that measure blood pressure, sensors that measure blood sugar level, sensors that measure movement of the user (e.g. acceleration, velocity, the number of steps, rotation, etc.), and sensors that measure blood flow. A healthcare related device 100 may automatically obtain and send healthcare related data about the given patient to the decision making server 500. The computing device 100 may also receive input from the given patient, which is sent to the decision making server 500. The patient input may be an indication of the patient's current health (e.g. feels healthy, feels sick, feels feverish, feels malaise, bruised bone, has abnormal body temperature, experiencing coughing, experiencing diarrhea, feels dizzy, etc.).

The computing device 100 is also configured to receive notification about automatic real-world actions that took place (e.g. booked appointments, ordered tests, ordered healthcare products, etc.) and to receive recommendations for taking real-world actions.

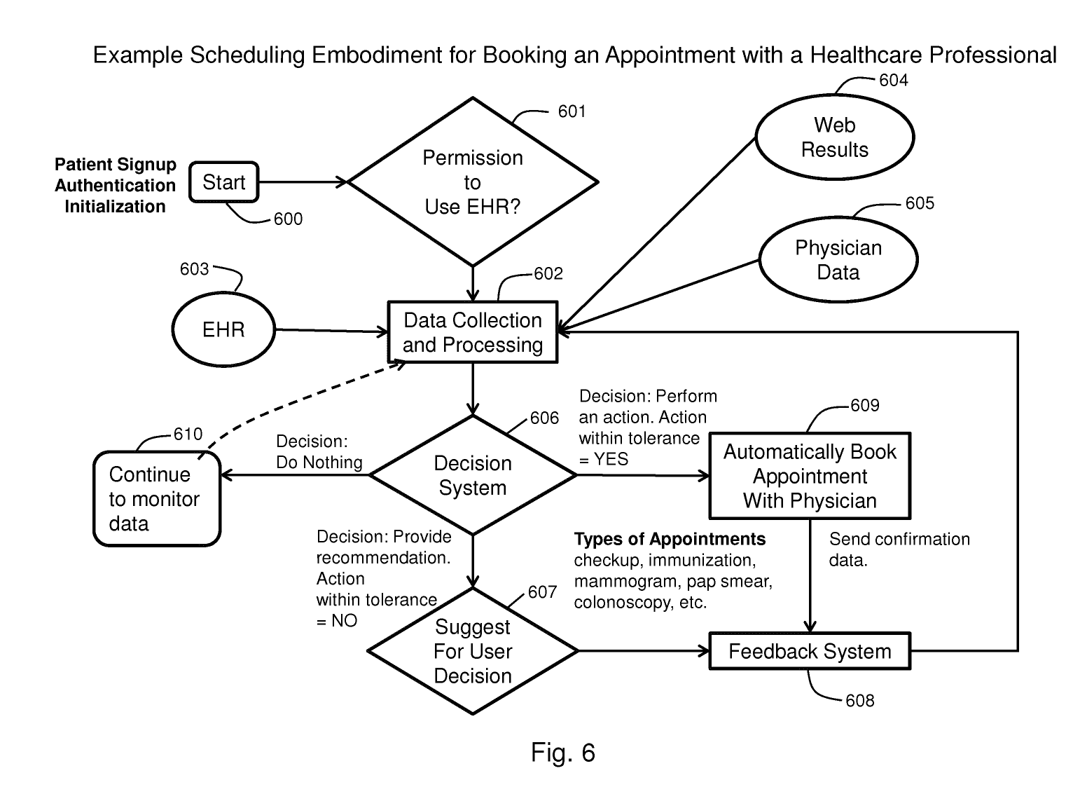

Turning to FIG. 6, example computer executable instructions are provided for automatically booking an appointment with a healthcare professional. For example, these instructions are executed by the decision making server 500. At block 600 there is an initialization process, which may include a patient signup process and an authorization process. For example, the patient provides login credentials for the healthcare computing system, contact information, their demographic information, and permission for the healthcare computing system to access other data about the patient (e.g. the patient's electronic health records ‘EHR’, social networking data, calendar data, user specific preferences, etc.).

At block 601, the server 500 determines if permission has been granted to access and use the patient's EHR. If so, the process continues to block 602 at which a data collection and processing module on the server is used to collect data about the patient and process the collected data. The data may be specific to the patient or may be general to the patient's demographic. For example, data specific to the patient is collected from patient's EHR (block 603), which may include appointment history, prescriptions, clinical tests and reports, historical diagnoses, and family medical history. Data specific to the patient may also be collected from other sources, such the patient's computing device 100, and the patient's software applications (e.g. for the calendar, location positioning, social networking data, etc.). Data may also be obtained from the Internet to obtain medical publications, historical disease trends, and disease forecasts (block 604). The data collection and processing module is also configured to obtain data from the healthcare professional, including their contact information, office location, and calendar information.

The data collection and processing module uses the collected data to establish tolerances for the patient and the healthcare professional, and to establish rules and preferences for recommendation and decision making process.

Examples of tolerances include ensuring a recommended appointment with a healthcare professional falls within a certain time of day, or on a certain day of the week, or both. Such an example tolerance may be driven by calendar availability of both the patient and the healthcare professional.

Another tolerance may be that the appointment must be made before a certain deadline, which is established according to healthcare guidelines. For example, based on certain physiological symptoms and the patient's medical history, the patient must see the healthcare professional within a certain time frame.

Another tolerance level is based on the distance of travel between the patient and a certain healthcare professional. In other words, if the healthcare professional is located within a certain range of the patient, an appointment with the healthcare professional is recommended.

Another example tolerance level is based on the urgency of the appointment using a patient's medical history. For example, it is clinically important for a person to have regular appointments scheduled when the person is in their early 50s and has recently been diagnosed with hypertensive heart disease. Conversely, if the person is 18 years old, without any remarkable medical conditions, normal BMI, and in overall good health, the need for an appointment is considerably lower.

Additional examples that could provide a basis for computing tolerances/rules may include: patient's insurance provider/extended health care benefits, time between previous appointments, pre-existing conditions (e.g. diabetes, requires dialysis, cancer treatments, etc.), medication regimen, prescription refills, and recurring tests/exams.

The decision making server then uses the processed data to determine a recommended real-world action for the patient using a decision module (block 606). The recommended real-world action may include booking an appointment for any one of a checkup, an immunization action, a mammogram, a pap smear, an eye examination, a dental examination, a blood work examination, a colonoscopy, etc. If the real-world action is within the tolerances, then the action to book the appointment is automatically made between the healthcare professional and the patient (block 609). No input from the healthcare professional and the patient is required to book the appointment. After the appointment is made, a confirmation of the appointment is sent to the feedback system 608. The patient may do nothing (which is considered positive feedback), may cancel the appointment (which is considered negative feedback), or may modify the appointment (which can be considered positive or neutral feedback, or both).

If the recommended appointment booking is not within tolerance, then the recommended appointment booking is sent to the patient for review using their computing device (block 607). The user may choose to provide authorization to schedule the recommended appointment, or may do nothing, or may choose to book the recommended appointment but with one or more modified parameters (e.g. a different time, a different location, a different healthcare professional, etc.).

The feedback from blocks 607 and 609 are entered into the feedback system (block 608). This collected feedback is sent from the feedback system 608 to the data collection and processing module 602 to update tolerances, preferences, etc.

For example, if an appointment has been automatically booked, and the patient has taken no action, and the patient arrives at the scheduled appointment, then the automatically booked appointment is considered to have been successfully recommended. Therefore, the parameters used to determine preferences and tolerances are reinforced, and additional evidence is provided which supports their applicability for future use.

In another example of how negative feedback affects future recommendations, if a user declines an appointment, it could be that the user has a persistent scheduling conflict during the week. This negative feedback is used to ensure that future appointments are not scheduled at this same time during the week.

The feedback may also tighten tolerances by flagging certain days of the week or time of day as off-limits, even if the user's calendar would otherwise indicate the user is available. For example, the system could draw this conclusion if several appointments within a normal “working day” are cancelled or rescheduled to periods outside of Monday to Friday, 9 AM to 5 PM.

If, from block 606, no recommended action is made, then no action is taken. The process continues to block 610, which includes the decision making server continuing to monitor the collected data. The process iterates from block 610 to block 602. It is appreciated that the data collection process at block 603, 604 and 605 may be ongoing and continuous, even while the other operations are being performed.

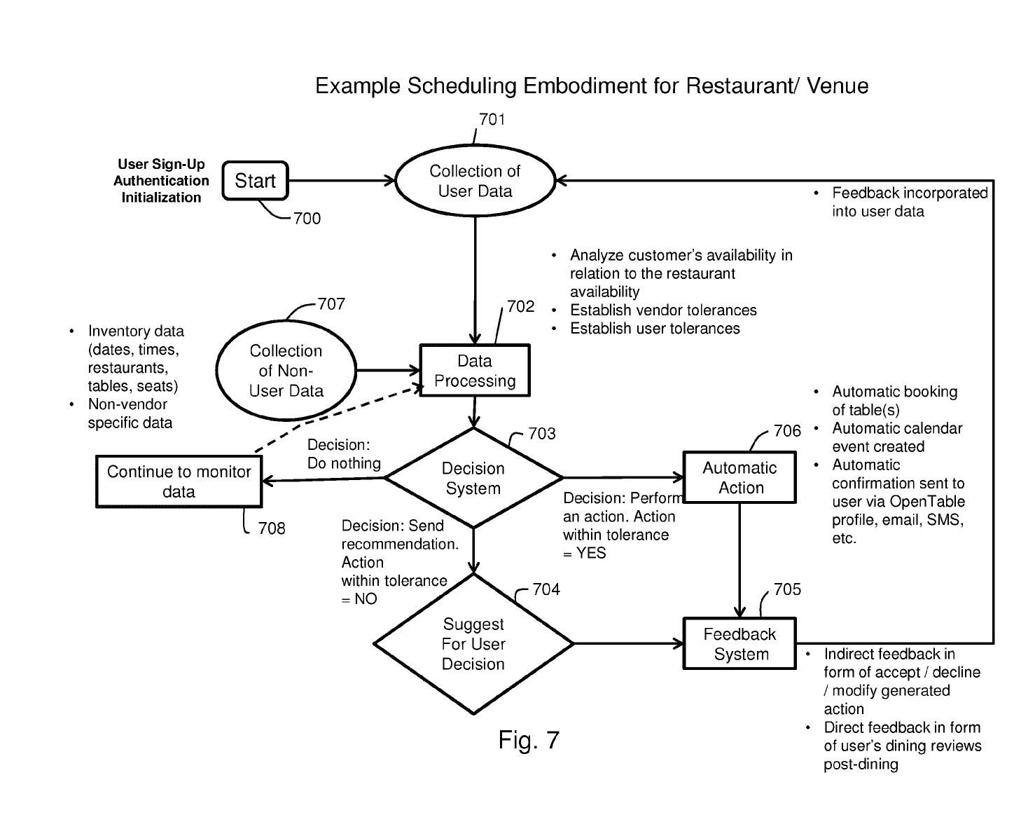

Turning to FIG. 7, example computer executable instructions are provided for scheduling a reservation for a restaurant or, more generally a venue. These executable instructions can be implemented by an automatic booking system, for example, having a similar structure to any of the structures shown in FIG. 1A, FIG. 1B and FIG. 2. At block 700, an initialization process is performed and it may include an authentication process and a user sign-up process. For example, a user provides permission for the automatic booking system to access the user's computing device or applications, or both. For example, information from the user's calendar and contacts application, information about the user's home address and current location (e.g. as determined based on GPS and other positioning technology), information from the user's social networking accounts, information about the user's online search data, and information about the user's preferences may be obtained by the automatic booking system.

At block 701, the automatic booking system automatically obtains the user data from the user's computing device and the user's applications. Other user data may also be obtained by way of direct inputs from the user. User data may also be collected from the automatic booking system database, or from databases located on connected partner organization or company servers. For example, a database belonging to a partner restaurant or venue company includes data about the given user's restaurant and venue preferences, the user's demographics, and the user's dining patterns. A non-limiting example of a restaurant or venue company is recognized under the trade name “OpenTable”, which assists users to make reservations with restaurants.

At block 707, the automatic booking system also collects non-user specific data. For example, data is collected about availability or inventory of possible reservations (e.g. dates, times, restaurants or venues, number of tables, number of seats, etc.). Furthermore, non-vendor specific data is collected, such as special occasions, holidays, promotional dining dates, weather conditions, etc. For example, if inclement weather conditions are expected (e.g. snow, freezing rain, hail, heavy rain, strong winds, extreme heat, etc.), the decision making system may recommend making a reservation at a restaurant that is closer to the user's location or may recommend making a delivery purchase to the user.

At block 702, when data specific to the user has been collected, or when non-user specific data has been collected, or both, the collected data is processed. The processing of the data includes analysing a user's potential interest in various dining locations. For example, by analyzing historical dining patterns, such as cuisine, price, location, table size, etc., the system establishes these patterns as preferences of the user. In particular, the more frequently repeated patterns in any of the parameters for cuisine, price, location, table size, etc., would be considered stronger preferences for the user over less frequently observed patterns.

Continuing with block 702, the data processing also includes automatically comparing the user's availability against a restaurant's availability or a venue's availability. In other words, time periods and dates that are mutually available for both the user and a restaurant or a venue are considered to be viable options.

Another timing factor that is considered includes determining the user's historical dining patterns, such as the times and dates the user typically dines at restaurants. Using the more prevalent patterns, as well as the user's upcoming availability, the system will identify restaurants or venues that have availability matching these user timing criteria.

The system is further configured to compute forecasted demands or desires of the user to make a reservation. For example, if Valentine's Day is approaching, the system will book a romantic restaurant for two people at least a certain time period (e.g. six weeks, or ten weeks, etc.) in advance of Valentine's Day. This advanced booking is to ensure the user is able to make a timely reservation at choice or popular restaurants. In another example, if the user's birthday is approaching, the system forecasts a dinner plan for a large party of people (e.g. n or more people). Therefore, the system will make a dinner reservation for at least n people on the birthday of the user.

The system is also configured to establish user tolerances and restaurant or venue tolerances. For example, a restaurant or venue may require that reservations are made no earlier than X number of days in advance of the reservation. Another tolerance may be that a restaurant requires a minimum number of people in a party to make a reservation. A tolerance level established from the user's perspective, by the system, is the type of food. For example, a reservation can only be made at restaurants that serve gluten-free food, or serve vegetarian food, or serve kosher food, or serve Halal food. Other user perspective tolerances can be related to price of food items on the menu and the location of the restaurant. It is appreciated that the tolerances and preferences may be automatically determined by the system based on the collected data. Alternatively or in addition, user input is used to establish tolerances and preferences.

Based on the processed data, the system computes possible reservation options that would satisfy the preferences of the user and identifies which of the possible reservation options would be most suitable for the user. This determination, for example, can be made based on heuristics or machine learning.

At block 703, it is determined if a recommended reservation is within the user's tolerance. If so, at block 706, the system automatically makes the reservation with the restaurant or venue on behalf of the user. No input is required from the user or the restaurant, or venue. Accordingly, for example, a calendar event is automatically created for the user identifying the reservation. An automatic confirmation message may also be sent to the user, for example via the restaurant server's messaging system, that the reservation has been made. For example, the confirmation may be sent via email, text message, or through an application.

If the recommended reservation is not within a user's tolerance, then the recommended reservation is sent to the user for their review (block 704). The recommended reservation may be sent via email, text message, or through an application. The recommended reservation may also include information about promotional dining periods (e.g. city-wide dining events), and can also recommend limited-time menus offered by restaurants.

At block 705, the system obtains feedback from the user, either implicitly or explicitly. For example, it is implicitly determined that a user has accepted the automatically booked reservation if no action is taken. This positive feedback is used to positively reinforce the data processing and decision making parameters (e.g. increase confidence value or weightings on criteria matching the previously made automatic reservation). If the user cancels the reservation or modifies the reservation, then this feedback is obtained by the system and used to improve the data processing and decision making factors (e.g. decrease confidence value or weighting on criteria matching the previously made automatic reservation).

Other feedback from the user may include the user's dining reviews (e.g. via OpenTable, Yelp!, Facebook “like”, star rating, etc.). Other feedback may also be gathered from block 704, based on whether the user acts upon the recommended reservation, or not.

This feedback can be used to improve the recommendation process. For example, positive feedback from a diner could be used by the system to confirm the diner's tolerances, strengthening the case for future reservations at the same, or similar locations, with the opposite occurring in the event of negative feedback. Neutral feedback may result in no change to diner tolerances.

Further, this feedback can also be used to improve the recommendation process as it relates to other users. For example, a positive or negative review could increase or decrease the reviewed restaurant or venue's ratings respectively, increasing or decreasing its likelihood of being suggested to a different diner/venue attendee with similar preferences or tolerances.

The system could also recognize and link the feedback to any number of users associated with the originating user. For example, the system could recognize that the dining party is identified specifically via a social media tag or message, and link the feedback to one or more associated users accordingly. In doing so, diner preferences for criteria such as type of cuisine, price, occasion, dining party size, date and time, and special requests could be used to improve future system decisions for the originating user as well as any associated users.

If, from block 703, no recommended action is made, then no action is taken. The process continues to block 708, which includes the decision making server continuing to monitor the collected data. The process iterates from block 708 to block 702. It is appreciated that the data collection process at blocks 701 and 707 may be ongoing and continuous, even while the other operations are being performed.

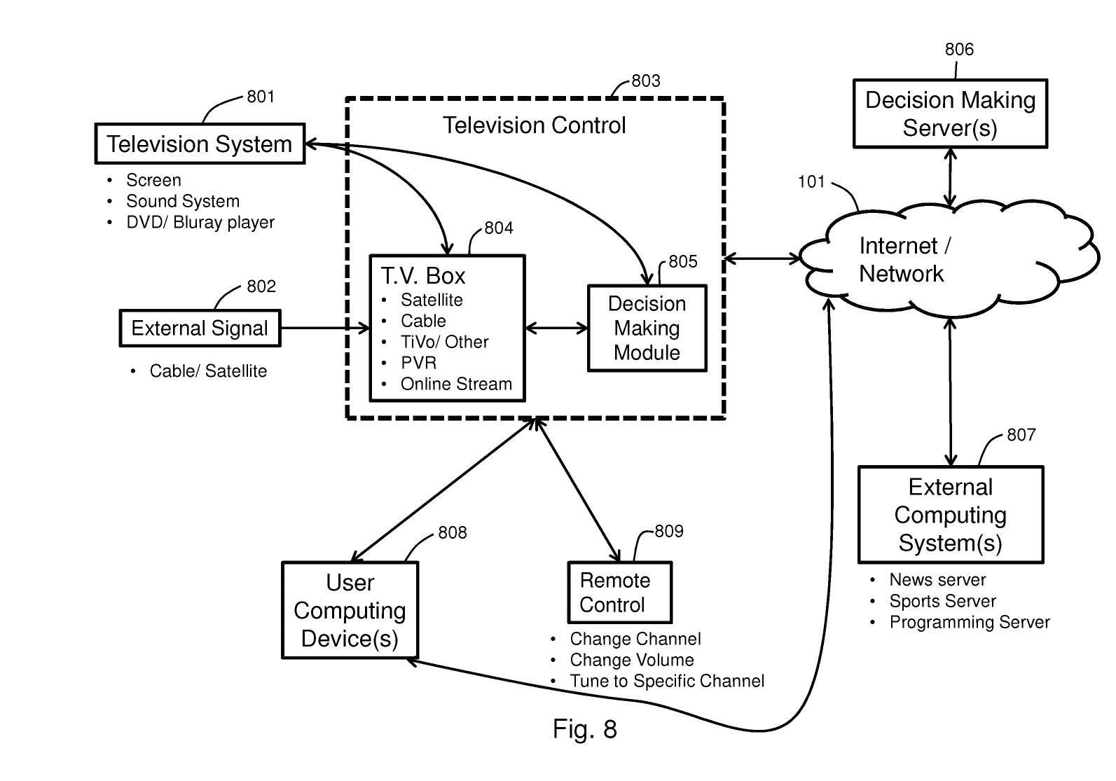

Turning to FIG. 8, an example embodiment of an automatic decision making system for television content control is provided. The system includes a television content control module 803 that includes a television box or device 804. Examples of a television box include a satellite box, a cable box, a digital box, a TiVo box, PVR (personal video recorder), a DVR (digital video recorder), and online streaming devices. The television box 804 is able to receive television content or other media content from an external signal 802, such as from cable, or satellite or the Internet. The television box 804 includes a memory and is configured to store television content and other media content received from the external signal 802. The television content control module 803 also includes a decision making module 805, which may be integrated with the television box 804, or may be a separate physical module.

The television content control module 803 is also configured to be in data communication with a television system, such as a display screen, a sound system, a media player (e.g. DVD or Blu-Ray player or other memory device player).

In an example embodiment, the television content control module 803 is also configured to be in data communication with one or more user computing devices (e.g. mobile phone, desktop computer, tablet, laptop, etc.). For example, a user can use their computing device 808 to view and set the recording settings of the television box, view media content that has been downloaded, and view media content that is available to be streamed or downloaded, or both.

The television content control module 803 is also configured to be in data communication with a remote control 809, which is used to change channels, control the volume, tune to specific channels, initiate the playing of content, initiate the fast-forwarding and rewinding of content, etc.

The television content control module 803, the user computing devices 808, a decision making server 806, and one or more external computing systems related to television or media content 807 are configured to be in data communication with each other using the Internet or another data network 101. The external computing systems 807 provide data about media content and television content, such as the time the content is originally available, a length of time of the content, a description of the content, genre of the content, the language of the content, the country of origin for the content, reviews of the content, and ratings of the content. The external computing systems 807 may include, for example, one or more of a news server, a sports server, a general programming server, a server dedicated to movies, etc.

It will be appreciated that either the decision making server 806 or the decision making module 805 may be used, or both may be used, to perform automatic control of television content or media related actions. The server 806 or the module 805, or both, may have the same or similar modules and databases as decision making module 102′.

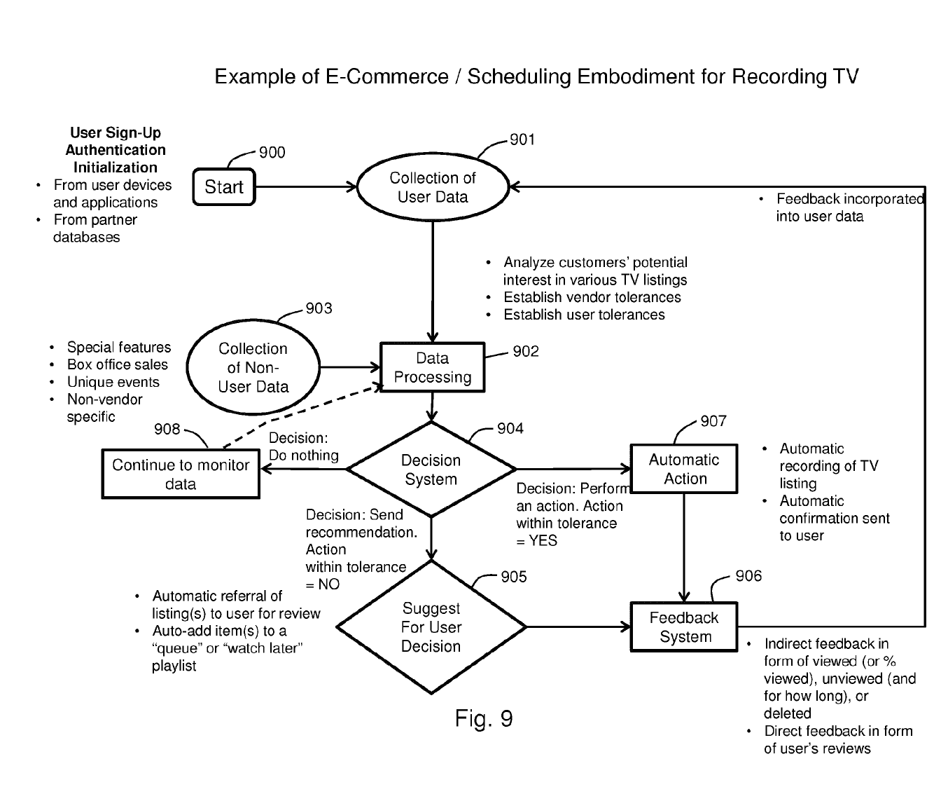

Turning to FIG. 9, example computer executable instructions are provided for automatically scheduling the recording of television or media content for future viewing.

At block 900, there is an initialization process, which may include a user-sign up process and a user authentication process. During this initialization process, the decision making module or server receives permission from a user's computing device to access data on the user's computing device and to access the user's data accounts. In other words, the decision making module can access and obtain information about the user (block 901). For example, the decision making module can obtain the user's calendar and contact information, the user's social network data, the user's media accounts (e.g. YouTube, NetFlix, iTunes, etc.), the user's online search data, etc. The user may also provide their demographic information, or the demographic information is automatically obtained from existing databases. The decision making module or server can also access and obtain data about the user's media or television viewing habits or trends, including the user's past television or media recordings (e.g. PVR recordings) and a history of past television or media content that was viewed by the user. Data associated with the viewed or recorded content, or both, may include the description of content, the actors in the content, the directors of the content, the genre of the content, the language of the content, when the content was viewed or recorded, if and when the recorded content was viewed, whether the entire program of the content was viewed or a portion thereof, the time length of the content, the review of the content, the rating of the content, and the cost of purchasing the content where applicable. It is appreciated that data about the user can also be obtained from the television box 804 and the external computing system 807.

At block 903, the decision making module or server is also configured to obtain non-user specific data. Examples of such data include special features of television or media content, box office sales of movie content, unique events (e.g. sport matches, Olympics, political events, emergency messages, etc.), and popularity rankings of television or media content (e.g. season premiere, finale, etc.).

Continuing with block 903, other data that is obtained, not specific to media or television, includes special occasion dates, holidays, weather, and political events. These other data can be used to affect or determine preferred media content for a user. For example, based on a special occasion (e.g. a natural disaster), the decision making module or server may consider recording television or media content related to the special occasion. In another example, if a snow storm is expected tomorrow, the decision making module or server will initiate the automatic recording of television or media content in the near present so that the user can watch the recorded content tomorrow if they spend more time at home due to the snow storm.

At block 902, the decision making module or server processes the collected data from block 901 and 903. The user's potential interests in various television listings are analyzed. The historical viewing patterns are analyzed. The decision making module or server compares the patterns extracted from the user's historical viewing patterns to identify current or future television or media listing that match or are similar to the user's historical viewing patterns.

For example, each time the user watches or records a program, the data is stored. For each program, associated data about the program (genre, actors, air date and time, season, episode, duration, etc.) can be utilized to identify what the user watches the most, and when. As an example, if the user regularly watches new episodes of a drama series, a decision can be made to record the new episode when it becomes available.

The decision making module or server also uses the collected data to forecast demand. For example, if the user is known to watch television on evenings and weekends, the decision making module will recommend recording television or media content in advance to be available and ready for viewing on the evenings and weekends. In another example of forecasting, if it is known from past viewing patterns that the user watches a certain sports team play, and if it is known that the certain sports team will be playing at a given future time period and televised on a given channel, then the decision making module or server will recommend that the television box be scheduled to record the television content during the given future time period on the given channel.

The decision making module or server will also establish vendor tolerances. For example, the television box may be only configured to store a certain amount of data (e.g. a certain number of hours of television content or media content). Another tolerance may be that the television box may have a maximum time period for which a television or media recording can be scheduled in advance. The media or television content distributor may set a tolerance or restriction preventing content from automatically being recorded from channels that are not part of a user's television or media service contract. Other example tolerances are the number of programs that may be recorded, or the duration of each program to be recorded.

User tolerances may also be established. For example, the user may restrict the number of shows or the numbers of episodes that are recorded. The user tolerance may also be based on the number of unwatched episodes that have been saved for the user. For example, if there are N or more episodes for a television show that have been already saved but have not been watched, then future episodes for the same television show will not be recorded.

The decision making module or server may also set user-perspective tolerances on whether pay-per-view media is able to be automatically recorded. The user-perspective tolerances may also be based on the ratings of the content (e.g. rated PG, rated R, etc.). Another user-perspective tolerance may be based on the cost for recording television or media content (e.g. maximum or minimum costs).

It can be appreciated that the decision module or server automatically makes a set of recommendations to record certain television or media content for the present or the future. The tolerances regarding automatic recordings may also be automatically established (e.g. obtained or computed) using the collected data.

At block 904, the automatic decision making module or server determines if a recommended recording is within the tolerances or not.

If the recommended recording is within the tolerances, then the automatic decision making module generates a command to automatically proceed with scheduling the recommended recording or to automatically proceed to start the recommended recording (block 907). This may also include automatically charging the user's credit card or other payment account for the recording of the television or media content. This automatic action may also include automatically sending a confirmation or notification (e.g. via email, text message, or other messaging platform) to the user that television content has been scheduled for recording or has been recorded, or both.

If the recommended recording is not within tolerances, then the automatic decision making module or server does not automatically schedule the recording or proceed with the recording. Instead, the automatic decision making module or server provides a message or notification to the user that suggest the recommended recording of the television or media content (block 905). The recommended recording may also be added to a “watch later” or “queue” playlist. The automatic decision making module or server then may receive an input from the user to proceed with the recommended recording, or may not receive any input regarding the recommended recording.

At block 906, feedback from blocks 907 and 905 are analyzed. For example, indirect feedback from the user is computed based on the percentage of viewed automatic recordings, the percentage of unviewed automatic recordings, the viewing length of the user of an automatic recording, and whether an automatic recording was deleted. Direct feedback regarding the automatic recordings include the user's review of the content, social media responses (e.g. was the content shared?; did the user add “Like” tag to the content?; etc.), and forum responses.

The feedback is incorporated into the user data. In particular, the feedback are used to modify existing preference parameters, modify existing tolerances, create new preference parameters, or create new tolerances, or combinations thereof. This improves the accuracy of the data processing to provide more relevant recommended recordings.

If, from block 904, no recommended action is determined, then no action is taken. The process continues to block 908, which includes the decision making server continuing to monitor the collected data. The process iterates from block 908 to block 902. It is appreciated that the data collection process at blocks 901 and 903 may be ongoing and continuous, even while the other operations are being performed.

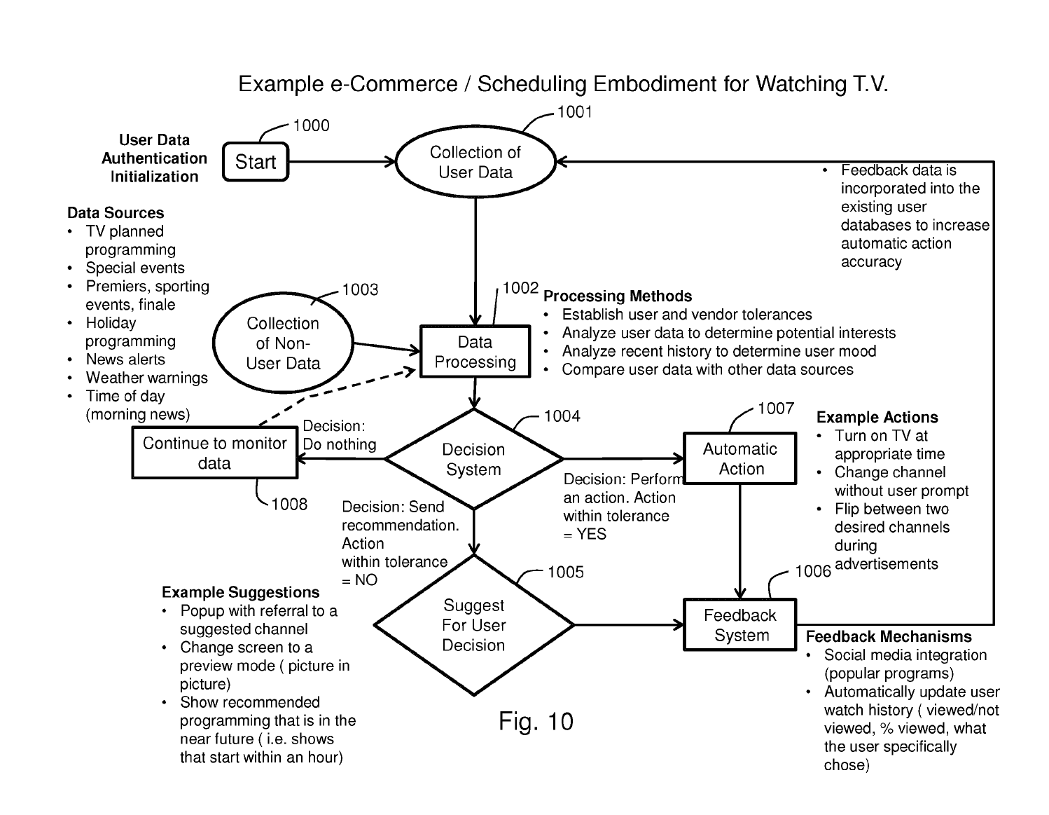

FIG. 10 shows example computer executable instructions for controlling the current viewing of television or media content, which may include the purchasing of such content for current viewing. Some of the operations are similar to those mentioned in FIG. 9.

Block 1000 is an initialization process that is similar to block 900. Block 1001 and block 1003 are respectively similar to blocks 901 and 903.

Block 1002, which is the data processing operation, is similar to block 902. Block 1002, however, determines recommendations for currently displaying television or media content. This may include content that is currently being displayed or very recent content that has been displayed (e.g. since the television was last turned on for viewing) to determine similar content.

For example, if the content recently being displayed includes comedy television shows, the automatic decision making module or server may recommend currently displaying another comedy television show on another channel. This applies to other genres of content (e.g. documentary, cooking shows, horror shows, soap operas, news, dramas, etc.).

In another example, if a season finale of a show series is currently being broadcasted on another channel different from the channel currently being viewed by the user, and the show series is one that is historically viewed by the user, then the automatic decision making module or server recommends switching from the currently viewed channel to the other channel.

In another example, if there is a weather warning being broadcasted on another channel different from the channel currently being viewed by the user, and the weather warning applies to the same location as the user, then the automatic decision making module or server recommends switching from the currently viewed channel to the other channel.

In another example, if it is observed that a user typically watches a show when it is broadcasted; and if it is detected that an episode for the show is currently being broadcasted; and if it is detected the television display is currently powered off; then, the automatic decision making module or server will recommend to turn on the television display to display the episode for the show.

It can be appreciated that other recommendations can be made.

The tolerances for automatically switching channels are also obtained, for example from the user directly or automatically generated from observing the user's patterns. For example, if it is observed from the collected data that the user only watches a certain set of channels, then the tolerance is set to only automatically display content broadcasted any one of the certain set of channels. In another example, if it is observed from the collected data that the user mostly does not watch television during certain times of the day or certain days of the week, then a rule is established to not automatically turn on the television display during those certain times and certain days. In another example, if it is observed that the user mostly switches between different channels during commercials, then a rule is established to automatically switch channels only during commercials. In another example, if it is observed that the user mostly switches channels after a television program (e.g. episode, movie, etc.) has ended, then a rule is established to automatically switch channels only after a television program has ended.

Another tolerance may be that a channel can only be automatically switched after a certain time period has passed from the last time the channel was switched. For example, the certain time period may be 1 minute, 5 minutes, 10 minutes, 15 minutes, 20 minutes, etc.

At block 1004, the automatic decision making module or server determines if a recommended action to currently switch a channel or currently display a channel is within tolerances. If so, the recommended action is automatically performed (block 1007). For example, a command is sent to automatically turn on the television display at the appropriate time. In another example, when a user is currently watching a channel, the television automatically changes to show another channel without any user input.

In another example, when a commercial starts on a first channel, the television is automatically switched to display a second channel. The second channel may be displayed for some time, without regard to the commercial ending on the first channel.

In another example embodiment, when commercials start on a first channel, the television is automatically switched to display a second channel. Further, when the commercials finish on the first channel, the television automatically switches back from the second channel to the first channel.

At block 1005, if the recommended action does not meet the tolerances, then the recommended action is provided to the user. For example, if the television is powered off, a message or notification is sent to the user's computing device providing the recommendation to turn on the television to a certain channel.

In another example, if the recommended action is to switch to another channel from the currently viewed channel, a popup message is displayed showing the recommended channel. Alternatively, the recommended channel is automatically displayed as a preview mode (e.g. picture in picture, or inset picture) while still displaying the currently viewed channel.

In another example, the recommended action may be a message displayed to the user indicating to change the channel to another channel at a certain time.

At block 1006, feedback from the user is obtained, either indirectly or directly from the user. For example, indirect feedback from block 1007 includes the user reversing the automatic action (e.g. negative feedback) or doing nothing after the automatic action has been completed (e.g. positive feedback).

Indirect feedback, based on block 1007, may include, after the channel has been automatically switched from a first channel to a second channel, it is detected the user has manually switched back to the first channel and then back to the second channel (e.g. within a certain time period). This feedback is considered positive, but to a lesser extent compared to the feedback had the user simply continued watching the second channel (e.g. taken no action after the automatic action).

Other feedback mechanisms are similar to those described with respect to block 906.

The feedback is used to add or modify the data collected about the user (block 1001), which would in turn improve the accuracy of the data processing operations.

If, from block 1004, no recommended action is determined, then no action is taken. The process continues to block 1008, which includes the decision making server continuing to monitor the collected data. The process iterates from block 1008 to block 1002. It is appreciated that the data collection process at blocks 1001 and 1003 may be ongoing and continuous, even while the other operations are being performed.

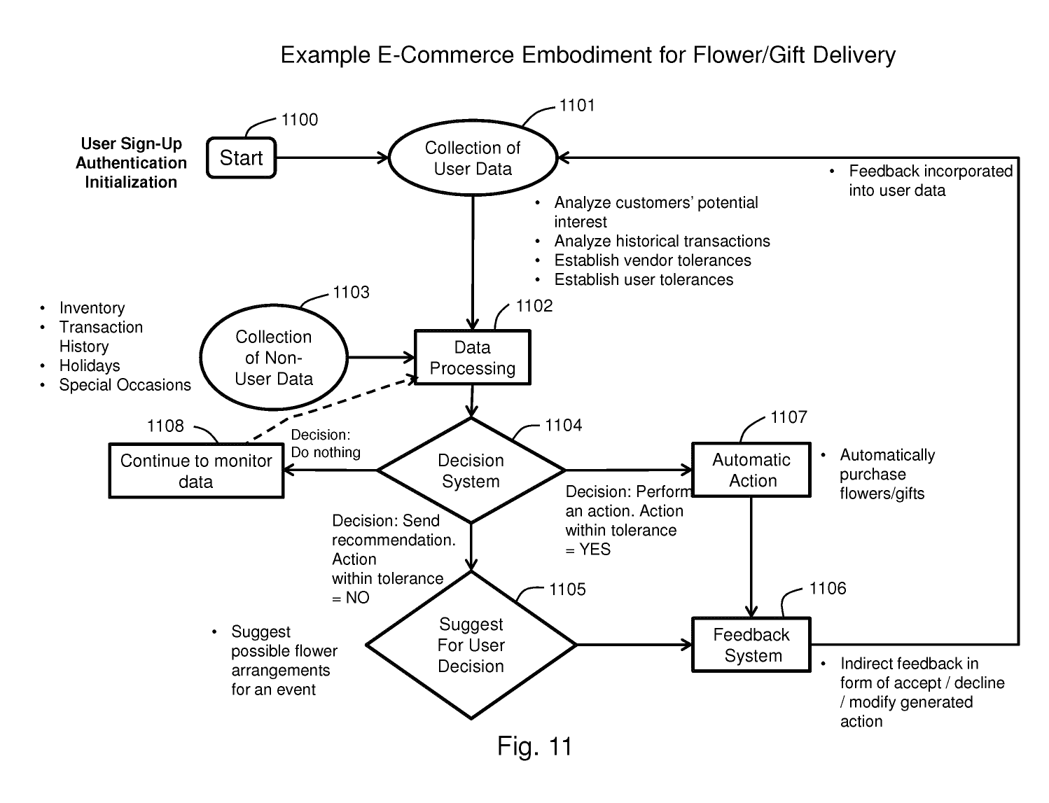

Turning to FIG. 11, example computer executable instructions are provided for automatically deciding and purchasing flowers or gifts for delivery. Example embodiments of computing systems for facilitating such operations include the computing systems shown in FIG. 1A, FIG. 1B and FIG. 2.

In this example, the partner company is a floral or gift (or both) wire service company that brokers orders from customers (e.g. people or parties) to florists for delivery. An example of such a flower and gift company is Teleflora, which operates a website www.teleflora.com.

The example of FIG. 11 is explained in an example user scenario in which the user Mike is an existing customer of the partner company, and who has purchased flowers within the last year. As per block 1100, the decision making server has received Mike's permission and initialization inputs, such as an acceptance of a terms of use agreement and a permission to share information.

At block 1101, the decision making server collects user data about Mike. This includes automatically obtaining data about Mike, which has been recorded by the flower and gift company. This data collection process requires not input from Mike.

Additionally, the decision making server automatically obtains data that Mike has shared from his calendar, contacts, social network, etc. This collection of data is completed without user interaction.

At block 1103, non-user data is collected, including guidelines. For example, the decision making server automatically obtains all data from the flower and gift company, such as information about past orders (e.g. types of flowers or gifts, timing of orders, location of deliveries, etc.). The information about past orders may also include data about specific florists, such as their delivery times, and customer reviews and ratings. This data about historical delivery orders is also mapped to compare the number of delivery orders over time, and this mapping is used to automatically compute local maxima and local minima. In this way, busy periods (e.g. times when there are local maxima) and less-busy periods (e.g. times when there are local minima) are identified for the flower and gift company.

Other non-user data that is collected includes information about currently available product inventory, the associated price or cost data for each product, the shipping or delivery cost of each product, and the estimated delivery time of each product. Data about sales or discounts are also obtained.

Continuing with block 1103, data about the dates and trends associated with special events, occasions, and holidays are also automatically obtained from the Internet or other computing systems.

At block 1102, the data collected from blocks 1101 and 1103 are processed. For example, the following profile is established about Mike: he is a male; his age is now 40; and based on his address, Mike lives in a middle-class neighbourhood. By processing his purchase history, Mike's last purchase was a dozen red roses. Based on his billing history, Mike's last purchase was made with a Visa card, which is currently active and has not expired.

Continuing with block 1102, based on the delivery history, the delivery address was the recipient's place of employment. The decision making server also determines from the delivery history that the recipient was Mike's wife. The last delivery or transaction was made on Feb. 10, 2013.

Therefore, based on the data, the system now knows the following information about Mike: male, 40 years of age, lives in middle-class neighborhood, previously purchased a dozen red roses for his wife on Feb. 10, 2013 using a Visa card, with roses delivered directly to his wife's office.

The decision making server cross-references this data with the birthday of Mike's wife, who is born on July 2. The data is also cross-referenced against other holidays (e.g. Valentine's Day on February 14). Therefore, since Feb. 10, 2013 does not fall within a close range of days around July 2, but Feb. 10, 2013 is close in date to Valentine's Day, then the data processing concludes that the flowers last purchased on Feb. 10, 2013 were purchased as a Valentine's Day gift.

Therefore, the decision making server generates Mike's preferences to purchase a dozen red roses in the same price range, which will be delivered to his wife prior to Valentine's Day in 2014. The decision making server searches the data about vendor inventory to identify a florist that can make such a delivery to Mike's wife for the same or similar cost (e.g. +/−15% cost difference).

In the example, the decision making server identifies a florist that is offering to deliver a dozen roses to the employment address of Mike's wife prior to Valentine's Day. However, the lowest cost found is 20% more than the previous purchase on Feb. 10, 2013. The decision making server then generates a recommendation to make the purchase for this order using Mike's Visa card.

After processing the data, at block 1104, the decision system computes a likelihood value that Mike would be happy or satisfied with another purchase of a dozen red roses near Valentine's Day 2014, to be delivered to his wife's office. In this case, there is a high likelihood of satisfaction because the parameters are aligned, except for the cost.

Continuing with block 1104, the system determines if the recommended flower order is within tolerances. In this example, the cost is not within tolerance.

Therefore, the process continues to block 1105, in which a message or notification is sent to Mike (e.g. via text, email, or an application) to recommend that Mike review and authorize the order of a dozen roses for delivery to his wife's place of employment prior to Valentine's Day. The message or notification will also provide Mike with the cost for making the purchase, and will also display the cost difference between the current recommended purchase and the previously made purchase.

Mike then reviews the notification of the recommendation and decides to purchase the roses, but modifies the purchase order to be half a dozen roses instead of one dozen. The computing system also receives feedback that Mike has added a Valentine's Day card from the florist company to his purchase. Mike has noted that the shipment address to his wife's workplace is unchanged and that he will pay for the flower delivery using the same Visa card as last year.

The process continues to block 1106, which collects and processes user feedback. In this example, the system computes a positive or neutral response based on Mike's modified flower delivery purchase. The system updates Mike's preference data with purchase details. For example, the purchase of the half-dozen roses from the flower company is used to strengthen user tolerances (e.g. increase confidence or likelihood value that Mike prefers to make a purchase from the flower company).

The modification to decrease the quantity of flowers is used as feedback to further restrict the cost tolerance. For example, for future purchases, recommended flower deliveries will be of the same or similar cost to the cost of the half-dozen roses.

The purchase of the same type of flowers (e.g. red roses) is used to increase the confidence value that red roses are preferred over other roses for Valentine's Day.

The purchase of the flowers prior to Valentine's Day is used to increase the confidence value that Mike prefers to send flowers to his wife prior to Valentine's Day in the future.

The purchase of a card in the present purchase is used to generate a preference parameter about Mike and Valentine's Day, indicating that he prefers to send a card along with flowers for future flower delivery purchases for Valentine's Day.

It is appreciated that this feedback data is incorporated into Mike's user data (block 1101). It also appreciated that known statistical computations and heuristic analysis can be used to adjust the weightings and likelihood values of Mike's purchasing preferences.

As an example, which uses machine learning, the feedback would provide more labelled data to the algorithm. This will update the model parameters to reflect the new relationships between the model features and their associated labelled actions.

In another example scenario, had the decision making server identified a florist that was able to deliver one dozen roses at a similar or same cost as the previous purchased delivery of Feb. 10, 2013, then the decision making server would recommend such a purchase. At block 1104, the decision making server determines that the recommended purchase is within tolerances (e.g. type of flowers, date, cost, etc.) and automatically purchases the flowers for delivery using the same Visa credit card used in the previous purchase (block 1107). No user input is made during the recommendation and automatic purchase of the flower delivery. Feedback from the user may be obtained directly (e.g. user cancels automatic purchase of flower delivery) or indirectly (e.g. user does nothing).

If, from block 1104, no recommended action is determined, then no action is taken. The process continues to block 1108, which includes the decision making server continuing to monitor the collected data. The process iterates from block 1108 to block 1102. It is appreciated that the data collection process at blocks 1101 and 1103 may be ongoing and continuous, even while the other operations are being performed.

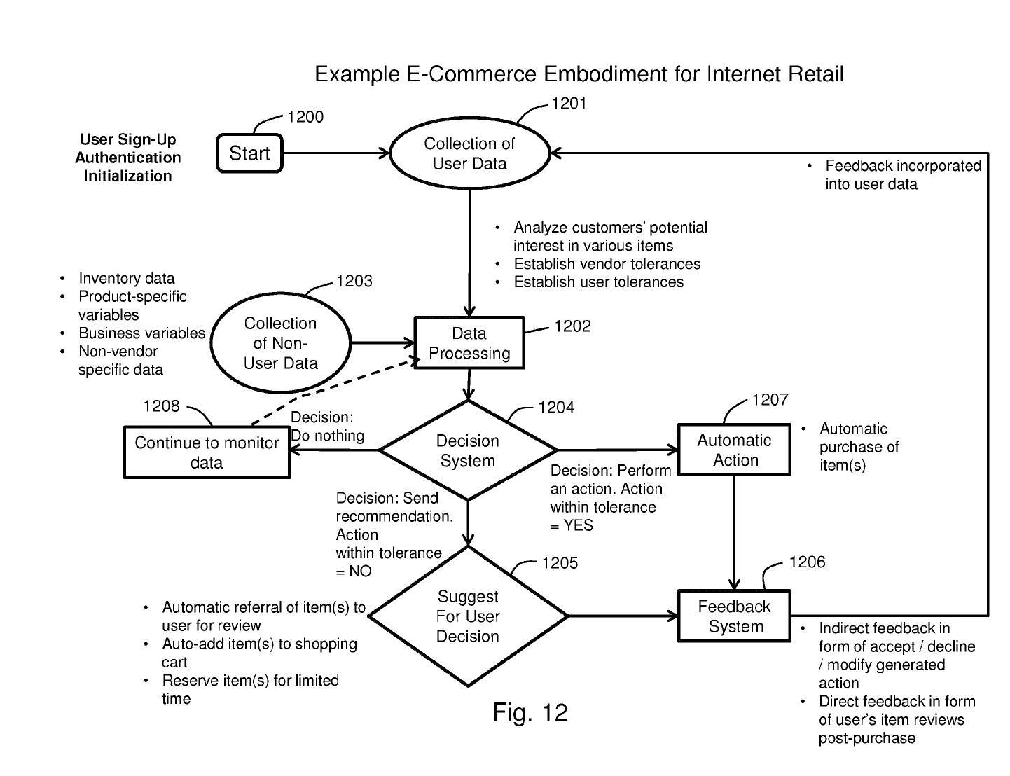

Turning to FIG. 12, example computer executable instructions are provided for automatically recommending a purchase for a service or a product, and automatically performing the purchase on behalf of a user, without user input. The partner company in this example is an e-commerce company, also called on online retailer. Non-limiting examples of online retailers include Amazon, Walmart, Target, Saks, e-Bay, TaoBao and Alibaba. Any of the computing systems shown in FIG. 1A, FIG. 1B and FIG. 2 may be used to facilitate the operations described with respect to FIG. 12.

In an example scenario, Mike is an existing customer of the Internet retailer, and he purchased a first book in a highly anticipated series of novels two years ago through the Internet retailer. Last year, he purchased the second book in the same series, after pre-ordering the second book online. The third book in the series is due to be released shortly.

At block 1200, the initialization process includes granting the computing system permission to obtain the user's data and act on behalf of the user. This may also include allowing the computing system to use Mike's payment information to automatically make purchases on his behalf. The initialization process can be completed through a centralized Internet portal or application, or via the Internet retailer's website.

It is appreciated that the principles described herein can be combined with currently known or future known predictive and forecasting models used for anticipatory shipping. However, the proposed systems and methods described herein improve Internet retail by predicting demand and fulfilling (or recommending) an item to a specific individual, without any user input. It is recognized that Internet retailers wait for the order to fill, or be initiated by a user, before assigning a package to a specific individual (e.g. the customer).

In another example embodiment, different Internet retailers or different partner companies are in data communication with the decision making server. In this way, the decision making server is able to compare products and services across different Internet retailers to determine a recommended product or service for purchase, which best meets the preferences and tolerances of the customer.

At block 1201, the decision making server obtains data about the user. In an example embodiment, no user interaction is required to obtain user about the data. For example, the decision making server processes or collects data that the user Mike has allowed access to from his calendar, contacts, social networks, email, other vendor sites, etc.

The user data also includes data about the user's contacts, affiliates and activities in indirectly related domains. For example, if Mike has a spouse with an active profile with the decision making server, then Mike's spouse's data is collected. In a further example, Mike's spouse's wish list of items to purchase is obtained. The wish list, for example, includes products or services intended as gifts, or intended as household items, or intended for their children. Furthermore, if Mike had previously completed a survey related to his favorite activities during the summer, or related to some other domain, the answers to that survey are obtained to identify relevant products and services.

The decision making server also obtains data stored by the Internet retailer about Mike. This includes Mike's preferences explicitly expressed by Mike using past surveys or questionnaires. It also includes: individual demographic data; historical buying patterns; individual customer purchase history; e-commerce portal session data; and shipping and delivery information.

At block 1203, the system also collects data that is not specific to the user. This data, for example, is used to develop guidelines for recommending and automatically purchasing products or services. The data, for example, is collected from one or more different Internet retailers.

The data obtained at block 1203 includes, for example, inventory data of products and services, product specific variables (e.g. color, size, model types, etc.), cost, pricing, promotion data, margin, volume, and availability.

The data also includes financial, logistical, operational, and other “business” variables. The collected data may be static or dynamic, or a combination thereof. The data may also be updated, for example, in real time. These business variables include, for example, price data, inventory data, and shipping data.

Data that is not specific to the Internet retailer is also obtained, for example, from the Internet or other information data servers. Examples of such data include: special events and occasions, holidays, general market or cultural trends, and competitors' behavior (e.g. marketing, pricing, sales, etc.).

When data about the user and other non-user specific data has been collected, the decision making server detects a customer's potential interest in an item by analyzing one or more of the following: historical buying patterns; individual customer purchase history; e-commerce portal session data; bought and browsed data; length of online visit to e-commerce portal; specific web pages viewed and duration of views; links hovered over and duration of hovering; and shopping cart and wish list data (e.g. whether items were placed in a shopping cart or a wish list without resulting in an immediate order). Other channel data is also analyzed, such as previous telephone inquiries, salesperson contact, responses to marketing materials supplied through physical storefront, etc.

Continuing with block 1202, the decision making server also determines relatedness of particular items to items reflected in a customer's buying patterns. For example, purchase of a novel may trigger the system to consider novels of the same genre or novels written by the same author, as recommended purchases.

The data process also includes analyzing forecasted customer demand. For example, data about other consumers who are considered similar to Mike (e.g. other consumers who have the same demographics as Mike or have the same shopping patterns as Mike) are analyzed to forecast demand or predict the demands or desires of Mike. For example, if similar consumers have purchased or browsed certain items, then these purchased or browsed items are considered as recommended purchases for Mike.

Continuing with block 1202, tolerances for the Internet retailer are also computed. The tolerances may vary depending on current cost (e.g. item, transportation, etc.) and/or margin of the item. For example, the retailer's tolerances as they relate to cost may be wider, with a greater range of acceptable values for the cost parameter, higher if cost or profit margins are in the Internet retailer's favor, as the higher margins can offset some of the risk to the retailer if the consumer is not satisfied with the automatic purchase. In another example, the retailer's tolerances as they relate to cost or inventory may be narrower, representing a smaller range of acceptable values, lower for items that are more expensive, low-volume, or scarce in supply, as the automatic purchase of such an item for a consumer presents greater risk to the retailer. Other types of data can be reviewed to compute a risk value (e.g. a risk coefficient) exposed to the Internet retailer due to cost of refunds, or the cost of return shipping, etc.

If the retailer's tolerances are wider, less customer data may be required to automatically proceed with a purchase. For example, the automated purchase of a lower-priced item for a consumer may not be conditional upon a review of the consumer's payment or purchase history.

If the retailer's tolerances are narrower, for example, for items priced above a certain value, then the Internet retailer automatically verifies the customer data. This may include the user's history of returning items, disputing purchases, or having poor credit history, or combinations thereof.

Continuing with block 1202, the data processing further includes computing user tolerances for automatically purchasing items or services. In an example embodiment, the decision making server compares Mike's purchase history with Mike's browsing history on the given Internet retailer's website or any other competing Internet retailer's website. This comparison is made to identify a price range a user was willing pay for similar items. For example, the historical data shows that the user Mike viewed or browsed item A costing $x, item B costing $y, and item C costing $z, whereby items A, B and C are similar and x<y<z. The historical data also reveals that Mike purchased item B costing $y. Therefore, the computed cost tolerance for purchasing items similar to items A, B and C is up to a maximum of $y.

The historical data is also used to identify a range of dates that a user is tolerant to making a purchase. For example, holiday dates and special occasion dates are compared against the dates of past purchases made by Mike. If a date of a past purchase approximately coincides with a date of a special occasion or holiday (e.g. on the same day or within a few days from each other), then a tolerance rule is created that allows automatic purchases to be made for the user during future instances of the same identified special occasion or holiday. Non-limiting examples of special occasions or holidays include Black Friday, Boxing Day, Christmas, and Valentine's Day.

The historical data about the user is also used, for example, to identify discounts or promotions during which the user has typically purchased an item. For example, it is identified that Mike has only purchased an item of a certain type when that certain type of item is at a certain discount or below a certain price. Using this data, a tolerance rule is generated to only allow automatic purchases of an item of the same type if the same type of item is priced below a certain threshold or is on sale with at least a certain percentage discount off the original cost.

The historical data is also used, for example, to establish a tolerance related to purchasing new items of a certain type, also herein called an “early adopter” tolerance rule. For example, the historical data is used to identify that Mike purchases certain types of items (e.g. e-readers) shortly after these certain types of items are released. Moreover, Mike typically does not buy these certain types of items if they have been released for over a certain period of time. Therefore, a tolerance rule is created to only purchases items of the same type if the item has been since released within a predetermined period of time (e.g. within one week from the release of the item).

In an example scenario, the collected data about Mike (e.g. as per block 1201) includes the following:
Name: Mike Smith
Gender: Male
Date of Birth: Mike is now 40
Address on file: Mike lives in a middle-class neighborhood
Vendor history: Amazon
Purchase history: last purchase was the second novel in a series of novels
Billing history: last purchase was made with a Visa card; active, not expired
Delivery history: delivery address was the recipient's home
Shipping history: 2-day Prime membership
Recipient: recipient was the individual
Transaction date: Oct. 5, 2013

As per block 1202, the decision making server processes the data to determine that Mike is a male, aged 40, lives in middle-class neighborhood, and previously purchased the second novel in a novel series after pre-ordering it using a Visa card. The second novel was shipped to his home at no shipping cost to Mike within 2-days of making the order. It is identified that Mike has Prime Membership status with the Internet retailer “Amazon”.

The decision making server compares the transaction date of Oct. 5, 2013 against other dates (e.g. Mike's birthday, Mike's wedding anniversary, holidays, other events listed on Mike's calendar, etc.), and determines there is no corresponding other event or date with the purchase.

The decision making server computes Mike's preferences using the historical data, noting that Mike pre-ordered the second novel, and paid full price. Based on this data, the decision making server also identifies anticipated cost, price, volume, demand, and other Internet retailer variables for similar books in the same novel series or in similar genres or authors. The decision making server also identifies a new, third novel in the same novel series is to be released soon, and obtains the price of the third novel.

At block 1204, a decision making process is used to generate a recommended e-commerce purchase and to determine whether or not the recommended e-commerce purchase should automatically be made.

Currently known and future known forecasting models can be used to detect possible correlations on likelihood of the customer (e.g. Mike) purchasing an item. The forecasting model can be used to predict purchases of new items based on its similarity to existing items (e.g. the next novel in the novel series). Algorithms predicting demand can be similar or interoperable with algorithms for general inventory management. Forecast of customer demand for an item may provide a reasonable first-order heuristic for determining who the item is suitable for.

In an example scenario of Mike, applying the operation of block 1204, the decision process determines a high likelihood that Mike would be happy to buy the upcoming novel at release, to be delivered to his home at no shipping cost to Mike. In other words, this recommended purchase is considered a low risk to the customer, if the purchase was automatically made.

The decision process also determines a low likelihood that Mike would be unhappy and return the item to the Internet retailer. In other words, this automatic purchase is considered a low risk to the Internet retailer, and the retailer is more likely to tolerate a higher degree of uncertainty when processing the automatic purchase.

Continuing with block 1207, in this example, both Mike's tolerances and the Internet retailer's tolerances are met. Therefore, the decision making server automatically purchases the item (e.g. the third novel in the novel series), and the item is marked for shipment to Mike. In an example embodiment, “anticipatory shipping” is used. In another example embodiment, “just in time” shipping methods are used.

Preferably, shipping methods are used to improve the user experience and decrease shipping time.

In an alternative example embodiment to block 1207, at least one of Mike's tolerances or at least one of the Internet retailer's tolerances are not met, or both. Therefore, the recommended purchase of the third novel in the novel series is sent as a recommendation to Mike (block 1205). For example, the recommended purchase of the third book is automatically pre-populated in the Internet retailer's shopping cart for Mike. This may allow the novel to be more conveniently purchased using a one-click computing process. It can be appreciated that automatically populating the recommended item to be purchased in a shopping cart is more convenient than displaying a suggestion to the user to review the item, since less user steps are needed to purchase the recommended item.

In another example embodiment, the decision making server automatically reserves the recommended item for the user to review, while simultaneously holding the item for purchase for a set time period. For example, this can apply to limited time and/or limited quantity promotions, such as Amazon's “Gold Box”, “Deal of the Day”, or “Lightning Deals”, as well as similar time and/or quantity-limited promotions offered by other retailers. By reserving the item, the consumer is ensured the item provided that they provide a timely decision to purchase the item; if they do not decide to purchase the item promptly, or decide not to purchase the item, then the system can release the item for other consumers to purchase.

At block 1206, a feedback process is provided to obtain feedback from the user (e.g. positive feedback, neutral feedback, negative feedback, etc.). The feedback may include an indication of user satisfaction with the purchase. For example, the Internet retailer may use a star rating, or other source of feedback via social media. The decision making system updates the user data (e.g. Mike's data) with the automatically made purchase details. If there is no return of the automatically purchased item, then the purchase details are used to strengthen user tolerances and vendor tolerances. For example, future automatic purchases of similar items can be made, potentially at higher prices (e.g. higher by a predetermined percentage from the previous purchase cost). Similarly, the Internet retailer's tolerances associated with the user (e.g. Mike) are also increased.

If the feedback includes a decrease in the quantity of items purchased, for example, then the decision making server decreases the maximum quantity of the same or similar type of product purchased, which will be applied to future recommended automatic purchases.

Other types of feedback can be obtained and other ways of applying the feedback to modify the recommendation process and computation of tolerances are applicable to the principles described herein.

If, from block 1204, no recommended action is determined, then no action is taken. The process continues to block 1208, which includes the decision making server continuing to monitor the collected data. The process iterates from block 1208 to block 1202. It is appreciated that the data collection process at blocks 1201 and 1203 may be ongoing and continuous, even while the other operations are being performed.

It can be appreciated that, other than a one-time initialization process, no user input is required throughout the determination of recommended items for purchase and automatic purchasing of the recommended items.

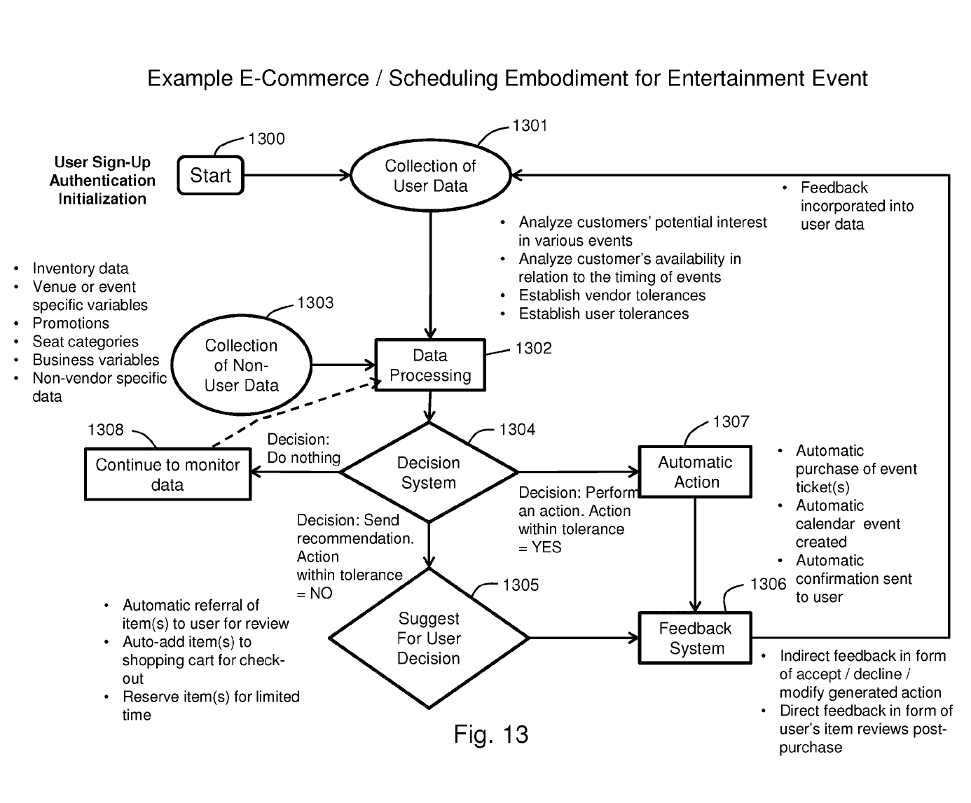

Turning to FIG. 13, example computer executable instructions are provided for scheduling and purchasing tickets for an event (e.g. entertainment event, political event, sports event, academic event, charity event, etc.). A partner company in this example is one that sells tickets for events (e.g. www.ticketmaster.com, www.stubhub.com, and other online computing platforms configured to sell tickets). Any of the computing systems shown in FIG. 1A, FIG. 1B and FIG. 2 may be used to facilitate the automatic scheduling and purchasing of tickets for an event on behalf of a user.

At block 1300 there is an initialization process, which may include a user sign-up process and authentication process. The user provides permission for the decision making server to access the user's computing devices and application. In this way, as per block 1301, the decision making server is able to automatically and continuously obtain information about the user, such as calendar and contacts information, social media information, and user preferences. The user's credit card information or payment information, and location is also obtained. Other information may be media content (e.g. books, movies, music, etc.) that has been consumed or browsed by the user. This media content information may be obtained from one or more online databases or media distribution computing platforms, such as YouTube, NetFlix, iTunes, etc. The user's online search data, preferences and information from other databases about the user are obtained. Demographic information and buying history information about the user is also obtained.

At block 1303, data that is not specific to the user is also obtained and stored. The collected data includes inventory data and venue or event specific parameters (e.g. number of seats available for a venue or event, seat categories, cost, timelines for purchasing event, historical data about how quickly seats sell out, location of the venue, whether the venue is indoor or outdoor, identification of similar events including timing and location, etc.). Other data collected includes promotion information about events or venues, seat categories, costs of a ticket, business variables, etc. The decision makings server also obtains and stores data about special occasion dates, holidays and weather.

At block 1302, the obtained data from blocks 1301 and 1303 are processed and analyzed. For example, the customer's potential interest in various events are determined by at least one of analyzing the customer's historical buying patterns and analyzing the relatedness of upcoming events to events from the customer's purchase history. Events, which match the customer's previous consumption of similar electronic media, are identified to be of potential interest to the customer. For example, if the customer has previously consumed music and music videos about a certain band, then a live concert of the same certain band would be an event that is of interest to the customer.

Continuing with block 1302, the decision making server also analyzes the customer's availability to attend an event of interest by reviewing the customer's upcoming calendar information. The decision making server may also analyze the customer's history of attending past similar events and identifying the dates and times of those past similar events.

The customer's demand for certain events is also forecasted. Tolerances of the ticket sales company and tolerances of the customer are also established.

It is appreciated that the computations made to identify recommended events, establish preferences, and establish tolerances may use heuristics, statistical analysis and machine learning.

At block 1304, the decision making server determines if the recommendation to purchase one or more tickets for the event is within tolerances. If so, the purchase of the event tickets is automatically made, without any customer input (block 1307). Delivery or pick-up information is automatically generated and provided to the customer. An automatic calendar event is also created in the customer's calendar application. An automatic confirmation of the purchased ticket(s) for the event is sent to the customer.

However, if the decision making server determines that the recommendation to purchase the one or more tickets for the event is outside at least one of the tolerances, then the recommendation is sent to the customer (block 1305). The recommendation provides the customer with the opportunity to review the recommendation and to provide consent to the purchase, denial of the purchase, or a modification to the purchase. The recommendation may be sent by email, text messaging, push notification, an automated telephone call, etc. In an example embodiment, the recommended purchase of the one or more tickets is automatically added to an Internet-based shopping cart, which allows the customer to quickly authorize the purchase of the tickets. In an example embodiment, the decision making server automatically reserves the recommended tickets for a predetermined amount of time and, if the customer does not purchase the tickets within the predetermined amount of time, the tickets are released for purchase by other customers.

At block 1306, feedback is implicitly or explicitly obtained by the customer based on the automatic purchase of the one or more tickets, or based on the recommendation to purchase the one or more tickets. The customer may also provide explicit feedback about the event, such as whether they like the performance and whether they liked the venue of the event.

The feedback about the customer is stored in the collection of user data and is used in future iterations to improve the processing of the data to determine recommended events and tolerances.

If, from block 1304, no recommended action is determined, then no action is taken. The process continues to block 1308, which includes the decision making server continuing to monitor the collected data. The process iterates from block 1308 to block 1302. It is appreciated that the data collection process at blocks 1301 and 1303 may be ongoing and continuous, even while the other operations are being performed.

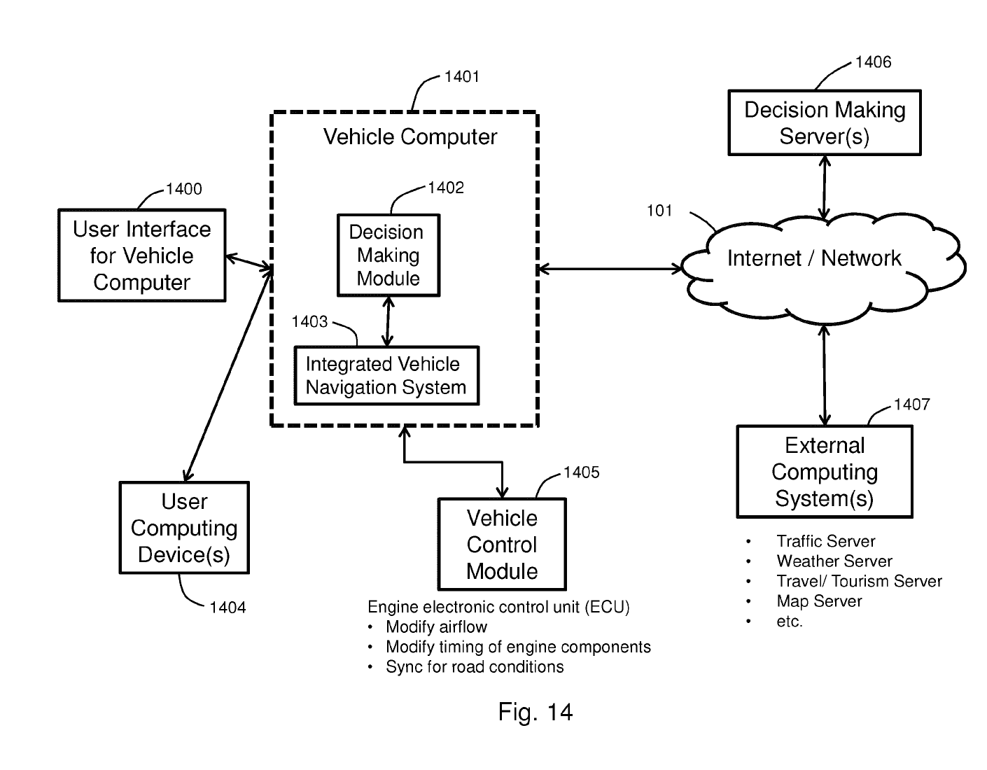

Turning to FIG. 14, an example computing system for automatically controlling the navigation and other aspects of a vehicle is shown. Non-limiting examples of vehicles includes cars, vans, trucks, boats, aircraft, manned vehicles, unmanned vehicles, submarines, etc.

Although specific details and examples are provided for a ground vehicle (e.g. a car), it will be understood that the general principles apply to other vehicles.

The system includes a vehicle computer system 1401, which includes a decision making module 1402 and an integrated vehicle navigation system 1403. The navigation system 1403 may be a GPS device, radar device, or other type of positioning device configured to provide navigation based on the vehicle's current location. A vehicle control module 1405 is in data communication with the vehicle computer system 1401. The control module 1405, for example, is configured to control the engine of the vehicle, the steering mechanism of the vehicle, modify airflow to the engine, modify timing of engine components (e.g. firing of pistons), modify steering, and modify spinning of wheels (e.g. for cars).

The vehicle computer system 1401 is also in communication with a user interface device 1400, which may be in the form of a display screen. The user's computing device or devices 1404 is also in data communication with the vehicle computer. Examples of a user's computing device include a mobile device, a tablet, a laptop, a desktop computer, a wearable computing device, etc.

The vehicle computer 1401, the user's computing device 1404, a decision making server 1406, and one or more external computing systems 1407 are also in data communication with each other. For example, these devices may communicate with each other through the Internet or another wireless network 101.

Examples of external computing systems 1407 include a traffic server, a weather server, a travel/tourism server, a map server, etc.

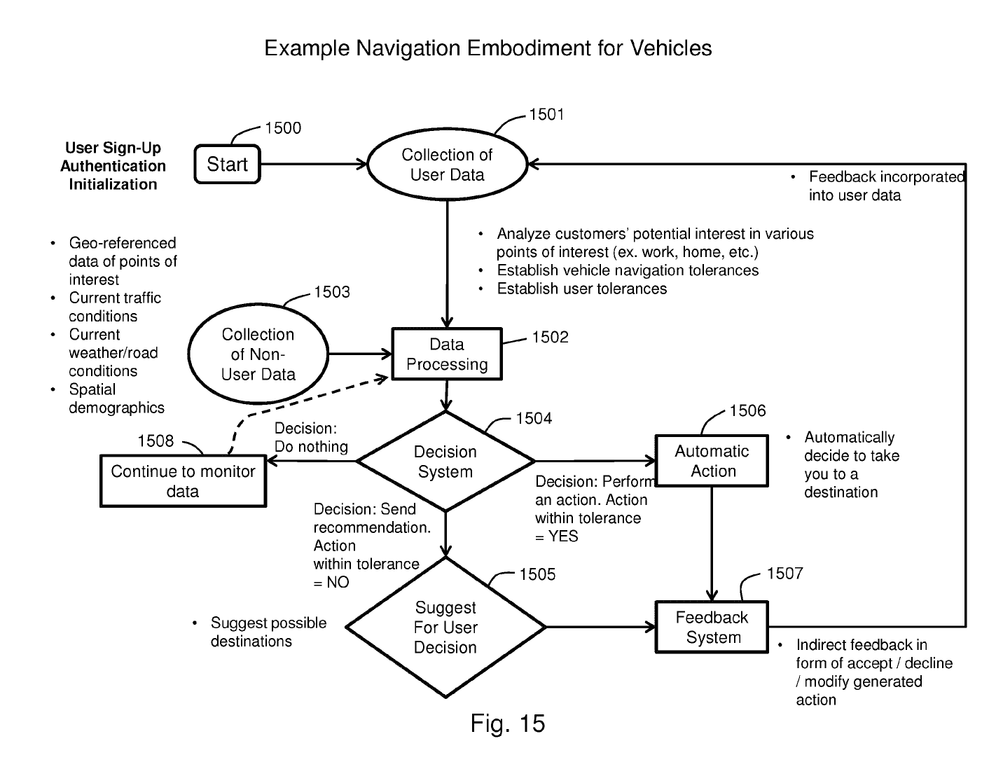

Turning to FIG. 15, an initialization process (block 1500) includes a user sign-up process and authentication process. The user allows the decision making server 1406 and the vehicle computer system 1401 to access the user's computing device and to access other applications and accounts related to the user.

At block 1501, data about the user is obtained and stored in memory. Data about the user includes calendar and contacts information, social media data, preferences, demographics, location patterns and travel patterns.

At block 1503, data that is not specific to the user is also obtained and stored in memory. This type of data includes geographical points of interest, current traffic conditions, current weather and road conditions, altitude, spatial demographics, angle of the sun based on location, etc.

At block 1502, the data that was collected and stored in memory from blocks 1501 and 1503 is processed and analyzed. The user's potential interests in various locations are determined (e.g. work location, home location, exercise location, friend's location, etc.). These user interests are determined, for example, by determining the locations, times and dates, and length of stay from the user's past. This can be obtained by viewing historical current positioning data, current positioning data, past calendar information, or present calendar information, or combinations thereof. For example, if the user historically drives to their friend's home every Saturday morning around 10:00 AM, and the current date and time is Saturday at 9:30 AM, a potential location of interest for the user is their friend's home. The likelihood value of the potential interest being their friend's home is increased by the user's calendar indicating a visit to their friend.

The potential location of interest to the user may also be determined by current traffic, road, or weather conditions, or combinations thereof. For example, if the weather and roads are very snowy and icy, then it may be unlikely the user wishes to travel by car.

Tolerances regarding the navigation and vehicle control are computed, for example, based on road conditions, weather conditions, and the type of vehicle (e.g. four wheel drive, torque of the engine, height of the vehicle body above the ground, speed limits of the vehicle, number of passengers in the vehicle, towing capacity of the vehicle, current fuel level of the vehicle, etc.).

Tolerances from the user's perspective are also automatically computed. These tolerances may include the maximum distance the user wishes to travel, the times during which the user wishes to travel, the maximum and the minimum speeds at which the user wishes to travel, and the locations or roads/highways that the user wishes to travel. These tolerances may automatically vary based on whether the user has passengers in the vehicle.

It is understood that the tolerances are computed based on the stored data from blocks 1501 and 1503.

At block 1504, if no recommendation is generated according to the preferences, then no action is taken, as per block 1508. The process continues at block 1508, which includes the decision making server continuing to monitor the collected data. The process iterates from block 1508 to block 1502. It is appreciated that the data collection process at blocks 1501 and 1503 may be ongoing and continuous, even while the other operations are being performed.

At block 1504, when a recommended action has been generated to automatically navigate the vehicle to a certain location, the decision making server or module determines whether the recommended action is within tolerances. If so, at block 1506, the decision is automatically made to control the vehicle to take the user to the certain location, as per the recommendation. The automatic control of the vehicle may also include controlling steering, controlling engine parameters, and controlling the environment of the vehicle's passenger cabin.

If the recommended action is not within tolerances, at block 1505, the recommended action is displayed to the user, for example, using the user interface 1400. The possible destinations are displayed or audibly communicated to the user. Routes may also be communicated to the user.

Implicit or explicit feedback from the user is obtained and incorporated into the database of the user data 1501. This feedback could be obtained by displaying or communicating the automatic or recommended destination(s) to the user after selection. Depending on subsequent actions taken by the user, the decision model can be updated accordingly.

General example embodiments are described below.

In a general example embodiment, a system includes: one or more data collection modules, a data processing module, a decision module, an actions module, and a feedback module.

In an example embodiment, a method is provided for generating a plurality of customized, user-specific actions without requiring any associated query or action from a user. The system generated action may automatically decision items within a preset tolerance, failing which, provides recommendations in a form suitable for the action.

In general, a system analyzes the user's activity in relation to multiple goods and service providers, noting all elements of the transaction, including but not exclusive to: date, time, item, method of purchase, delivery and billing address, dollar amount, discount %, etc. to automatically perform similar transactions for the user in the future.

The system is also configured to consider personal factors, such as demographics, the user's calendar, the user's family members' wish list, etc.

The system is also configured to consider factors specific to goods and service providers, such as price, inventory, business variables, and availability of products and services.

The system is also configured to consider influence factors, such as “Likes”, ratings, reviews, etc.

The system is also configured to consider external factors, such as holidays, special events (new launches), web results, etc.

In another aspect, the system is configured to receive a user's acceptance of Terms & Conditions for use. This may occur on a site-by-site basis, as each 3rd party may have slightly different terms for use and collection of user data.

In another aspect, the functions of the system can be performed centrally, or locally on a domain or partner-specific platform in a distributed manner.

In general, a data collection process is provided, which collects data x, y, z, etc. The data about the user is accessed or collected (e.g. demographics, schedule, current location, likes, dislikes, preferences, historical actions, etc.) either directly (e.g. through the means of a user interface) or indirectly (e.g. email, SMS/MMS, instant messaging, calendar, social networks, blogs, and public databases), or both. The data can include both user and non-user data from different sources. Examples of online service providers include Amazon, iTunes, OpenTable, TicketMaster, etc. Examples of user data includes the user's calendar information, contact information, and positioning information.

In another aspect of data collection, internal or entity specific application domain data includes reservation availability, physician schedules, inventory, customer demand, etc.

In another aspect of data collection, external or non-entity specific application domain data includes special events, holidays, seasonality, disease trends, scientific/industrial publications, government census, government publications, cultural norms, etc.

In another aspect of data collection, the collected data does not need to be stored locally on the system, and instead can be stored in a cloud-based computing system. The data can be accessed through local storage or memory, or through a network.

In another aspect of data collection, additional data is received from the feedback system, and is incorporated into the user data.

In a general example embodiment of data processing, it is determined if the collected data is greater than, less than or equal to certain other values (e.g. x>0, etc.). The data processing includes defining the set of automated actions that may be carried out by the system, conditional on satisfying user thresholds, internal constraints, legal constraints, external constraints, etc. The data processing also includes identifying, quantifying, categorizing, and/or labelling of features in the data, and analyzing how those features may be mapped to an action.

In another aspect, the data processing also includes the aggregation, transformation, cleaning and normalization of the collected data. For example, the processing includes removing outliers, transforming data to make sure it is all on the same time scale and spatial resolution, filtering out data that is irrelevant, etc.

In another aspect, the data processing also includes labelling data to map data features to associated actions from historical data.

In a general example embodiment of a decision system, the collected data is processed or estimated to determine recommendations (e.g. f(x, y, z, . . . )). For example, the decision system automatically prioritizes and determines the most appropriate action(s) that should be autonomously executed given a defined set of actions (defined in Data Processing step) and a set of constraints (ex. heuristics, machine learning, etc.)

In an aspect of the decision system, if a suggested action exists outside user tolerances, alternative action is suggested in lieu of autonomous execution (e.g. recommend for user decision).

In another aspect, the decision system passes a list of outcomes, each with a corresponding state of either “automate” or recommend” results to the action system. If no results are provided, the implied state is “No Action”.

In a general example embodiment of the action system, a real-world action is automatically performed without user input, or a recommendation is presented to the user. For example, the action system books a table, makes an appointment, buys flowers, etc. It carries out an action that is prescribed by a decision. The decision is a request. The action system is the processor of the request. It serves as a consistency check that the prescribed decision is plausible given the current system constraints. It also updates prioritization of decision requests given constraints at time of processing.

In an aspect, the action system carries out an action based on a query from the decision system.

In another aspect, the action system validates that a specified action is actionable at the time of processing.

In another aspect, the action system updates the action prioritization based on feasibility at time of transaction.

In another aspect, the action system prioritizes the sequence in which decisions are processed from a plurality of requests (e.g. places actions passed from the decision system into a smart queue).

In another aspect, the action system modifies actions based on user feedback. For example, a user wants to buy the recommended flowers, but also wants to change the type of flowers that were recommended.

In another aspect, the action system presents one or more recommended actions for user review if none of the actions satisfy the system thresholds for autonomously carrying out the action (e.g. the decision to recommend, which has been passed from the decision system).

In another aspect, the action system is configured with a user control to globally, or specific to a goods and service provider, terminate all automated actions.

In a general example embodiment, a feedback system is configured to collect feedback about an action from the user either directly, by presenting a UI, or indirectly, by making an assumption about a passive or active action.

In another aspect, the feedback system sends data to the data collection system so it can be ingested as historical user data.

In another aspect, the feedback system collects feedback directly (e.g. user tells the system that they like or dislike an action), or collects feedback indirectly (e.g. the user passively agrees or disagrees to perform the action).

For example, the feedback system receives a passive agreement from the user that may be interpreted as positive reinforcement, while an active user action of deleting/cancelling/refunding may be interpreted as negative feedback. Modifying an automatic action may be interpreted as a positive for the action, but a negative for the timing, or pricing of the action taken, for example.

In another general example, a method performed by a computing system is provided for automatically performing a real-world action, the real-world action including at least one of a scheduling action and a purchasing action, the method including: obtaining data about a user; obtaining data about a partner organization; processing the data about the user and the partner organization to recommend the real-world action and to generate a tolerance rule; when the real-world action is within the tolerance rule, automatically performing the real-world action for the user and in collaboration with the partner organization; and when the real-world action is not within the tolerance rule, providing a notification to the user recommending the real-world action be performed.

In an aspect, the method further includes obtaining implicit feedback or explicit feedback from the user after the real-world action was automatically performed, and using the implicit feedback or explicit feedback to modify the data about the user.

In another aspect, when recombining a subsequent real-world action, the modified data about the user is processed.

In another aspect, no user input is used to determine whether to recommend the real-world action and to automatically perform the real-world action.

In another aspect, the data about the user includes at least one of demographic information, calendar information, contacts information, location information, social media information, payment information, historic scheduling information, and historic purchase information.

In another aspect, the data about the user and the partner organization is processed to at least one of validate the data, aggregate the data, normalize the data, and remove one or more outliers in the data.

In another aspect, the data about the user and the partner organization comprises a history of one or more past real-world actions, and when the real-world action includes a feature that matches a feature of the one more past real-world actions, the real-world action is recommended.

In another aspect, multiple real-world actions are obtained based on processing the data about the user and the partner organization, a preference is computed based on processing the data about the user and the partner organization, and the preference is used to determine which one of the multiple real-world actions is to be recommended.

In another aspect, after the real-world action is automatically performed, a notification is sent to the user indicating the real-world action was automatically performed.

In another aspect, the real-world action includes automatically scheduling an event with the partner organization for the user to attend.

In another aspect, the real-world action includes automatically purchasing a product or a service, or both, from the partner organization for the user.

In another aspect, after the notification to the user recommending the real-world action is provided, the computing system receives an input from the user to proceed with performing the real-world action.

In another general example, a method performed by a computing system is provided for automatically scheduling a real-world healthcare appointment, the method including: obtaining data about a patient; obtaining data about a healthcare organization; processing the data about the patient and the healthcare organization to recommend scheduling the real-world healthcare appointment and to generate a tolerance rule; when the real-world healthcare appointment is within the tolerance rule, automatically scheduling the real-world healthcare appointment with the patient and the healthcare organization; and when the real-world healthcare appointment is not within the tolerance rule, providing a notification to the patient recommending the real-world healthcare appointment be scheduled.

In another general example, a method performed by a computing system is provided for automatically scheduling a real-world reservation with a venue, the method including: obtaining data about a user; obtaining data about the venue; processing the data about the user and the venue to recommend that a real-world reservation with the venue for the user be scheduled, and to generate a tolerance rule; when the real-world reservation is within the tolerance rule, automatically scheduling the real-world reservation with the venue for the user; and when the real-world reservation is not within the tolerance rule, providing a notification to the user recommending the real-world reservation be scheduled.

In another general example, a method performed by a computing system is provided for automatically performing a real-world purchase of at least one of a product and a service, the method including: obtaining data about a user; obtaining data about a retailer; processing the data about the user and the retailer to recommend the real-world purchase of at least one of the product and the service, and to generate a tolerance rule; when the real-world purchase is within the tolerance rule, automatically performing the real-world purchase for the user and in collaboration with the retailer; and when the real-world purchase is not within the tolerance rule, providing a notification to the user recommending the real-world purchase be performed.

In another general example, a method performed by a vehicle control computing system is provided for automatically navigating a vehicle, the method including: obtaining data about a user associated with the vehicle; obtaining data about the vehicle; processing the data about the user and the vehicle to recommend a navigation action for the vehicle and to generate a tolerance rule; when the navigation action is within the tolerance rule, automatically navigating the vehicle according to the navigation action; and when the navigation action is not within the tolerance rule, providing a notification to the user recommending navigating the vehicle according to the navigation action.

In another general example, a method performed by a computing system is provided for automatically recording television or video media, the method including: obtaining data about a user; obtaining data about a television or video media provider, including a schedule of one or more television or video programs; processing the data about the user and the television or video media provider to recommend a recording action of the one or more television or video programs and to generate a tolerance rule; when the recording action is within the tolerance rule, at least one of automatically performing the recording action and scheduling the recording action; and when the recording action is not within the tolerance rule, providing a notification to the user recommending to at least one of perform the recording action and schedule the recording action.

In another general example embodiment, a computing system is provided, which includes: a processor; a memory device; and a communication device configured to exchange data over a network. The processor is configured to at least perform one or more of the operations described herein.

It will be appreciated that the attributes of the proposed systems and methods described herein can be combined in different ways, although not explicitly stated. For example, an attribute described with respect to one example embodiment can be combined with a different example embodiment, although not explicitly stated.

The steps or operations in the flow charts described herein are just for example. There may be many variations to these steps or operations without departing from the spirit of the invention or inventions. For instance, the steps may be performed in a differing order, or steps may be added, deleted, or modified. The steps may also be performed by different modules other than the modules specified herein.

It will be appreciated that the particular example embodiments shown in the figures and described above are for illustrative purposes only and many other variations can be used according to the principles described. Although the above has been described with reference to certain specific example embodiments, various modifications thereof will be apparent to those skilled in the art as outlined in the appended claims.

1-13. (canceled)

14. A method performed by a computing system for automatically scheduling a real-world healthcare appointment, the method comprising:
obtaining calendar data and additional data about a patient;
obtaining calendar data and additional data about a healthcare organization;
processing the calendar data and the additional data about the patient and the calendar data and the additional data about the healthcare organization to recommend scheduling the real-world healthcare appointment and to generate an availability tolerance rule based on calendar availability of both the patient and the healthcare organization, and to generate at least one other tolerance rule that is based on the additional data about the patient or the additional data about the healthcare organization, or both;
wherein generating the availability tolerance rule and the at least one other tolerance rule includes the computing system accessing a database storing preferences or guidelines, or both, and computing system stores the availability tolerance rule and the at least one other tolerance rule in a tolerance rules database; and
after determining that the real-world healthcare appointment is within both the availability tolerance rule and within the at least one other tolerance rule, the computing system automatically scheduling the real-world healthcare appointment with the patient and the healthcare organization; or
otherwise, after determining that the real-world healthcare appointment is not within both the availability tolerance rule and within the at least one other tolerance rule, the computing system generating and sending an electronic notification to the patient recommending the real-world healthcare appointment be scheduled, the electronic notification receivable by a computing device of the patient.

15. (canceled)

16. (canceled)

17. (canceled)

18. (canceled)

19. The method of claim 14 further comprising the computing system obtaining implicit feedback or explicit feedback from the patient after the real-world healthcare appointment was automatically scheduled, and using the implicit feedback or explicit feedback to modify at least one of the calendar data and the additional data about the patient.

20. The method of claim 19, wherein when automatically scheduling a subsequent real-world healthcare appointment for the patient and the healthcare organization, the modified calendar data or the modified additional data, or both, about the patient is processed.

21. The method of claim 19 wherein the calendar data about the patient is modified, and comprises modifying a parameter of the real-world healthcare appointment.

22. The method of claim 14 wherein the additional data about the patient comprises demographic information.

23. The method of claim 14 wherein the additional data about the patient comprises contact information.

24. The method of claim 14 wherein the additional data about the patient comprises location information.

25. The method of claim 14 wherein the additional data about the patient comprises social media information.

26. The method of claim 14 wherein the additional data about the patient comprises the patient's electronic health record.

27. The method of claim 14 wherein the additional data about the patient is collectible via the computing device of the patient and is transmittable to the computing system.

28. The method of claim 14 wherein the additional data about the patient comprises patient input about how the patient currently feels, the patient input collectible via the computing device of the patient and transmittable to the computing system.

29. The method of claim 14 wherein the additional data about the patient comprises physiological sensor data.

30. The method of claim 29 wherein the physiological sensor data comprises blood pressure data.

31. The method of claim 29 wherein the physiological sensor data comprises electrocardiography data.

32. The method of claim 29 wherein the physiological sensor data comprises blood sugar level.

33. The method of claim 29 wherein the physiological sensor data comprises a number of steps.

34. The method of claim 29 wherein the physiological sensor data comprises blood flow data.

35. The method of claim 29 wherein the physiological sensor data comprises acceleration data.

36. The method of claim 29 wherein the physiological sensor data comprises rotation data.

37. The method of claim 14 wherein the additional data about the healthcare organization comprises at least one of contact information and location information.

38. A computing system for automatically scheduling a real-world healthcare appointment, comprising:
a processor;
a memory device comprising a tolerance rules database and a database storing preferences or guidelines, or both;
a communication device configured to exchange data over a network;
the processor configured to at least:
obtain calendar data and additional data about a patient via the communication device;
obtain calendar data and additional data about a healthcare organization via the communication device;
process the calendar data and the additional data about the patient and the calendar data and the additional data about the healthcare organization to recommend scheduling the real-world healthcare appointment and to generate an availability tolerance rule based on calendar availability of both the patient and the healthcare organization, and to generate at least one other tolerance rule that is based on the additional data about the patient or the additional data about the healthcare organization, or both;
wherein generating the availability tolerance rule and the at least one other tolerance rule includes the computing system accessing the database storing the preferences or the guidelines, or both, and the computing system stores the availability tolerance rule and the at least one other tolerance rule in the tolerance rules database; and
after determining that the real-world healthcare appointment is within both the availability tolerance rule and within the at least one other tolerance rule, the computing system automatically schedules the real-world healthcare appointment with the patient and the healthcare organization; or
otherwise, after determining that the real-world healthcare appointment is not within both the availability tolerance rule and within the at least one other tolerance rule, the computing system generates and sends an electronic notification to the patient recommending the real-world healthcare appointment be scheduled, the electronic notification receivable by a computing device of the patient.
